(19) United States
(12) Patent Application Publication
(10) Pub. No.: US 2025/0358671 A1
(43) Pub. Date: Nov. 20, 2025

(54) WIRELESS COMMUNICATION IN ASSOCIATION WITH AN L4S PROTOCOL - APPLICATION PROCESSOR ASPECTS

(71) Applicant: QUALCOMM Incorporated, San Diego, CA (US)

(72) Inventors: Sitaramanjaneyulu KANAMARLAPUDI, San Diego, CA (US); Arnaud MEYLAN, San Diego, CA (US); Vamsi DOKKU, San Diego, CA (US)

(21) Appl. No.: 19/208,534

(22) Filed: May 14, 2025

Related U.S. Application Data
(60) Provisional application No. 63/648,621, filed on May 16, 2024.

(51) Int. Cl. H04W 28/02; H04L 5/00

(52) U.S. Cl. CPC H04W 28/0268; H04L 5/0053; H04W 28/0236; H04W 28/0284

(57) ABSTRACT

The apparatus may be a wireless device or user equipment (UE) configured to obtain a first plurality of generated packets including information related to the L4S service and process, based on the information related to the L4S service, the first plurality of generated packets for transmission by the UE. The apparatus may be a network device configured to some examples, a network device may be configured to include, in each received UL packet of a first plurality of received uplink (UL) packets, explicit congestion notification (ECN) information related to radio network delays and output, for a core network, the first plurality of received UL packets including the ECN information related to the L4S service.

### CROSS REFERENCE TO RELATED APPLICATION(S)

This application claims the benefit of and priority to U.S. Provisional Application Ser. No. 63/648,621, entitled “WIRELESS COMMUNICATION IN ASSOCIATION WITH AN L4S PROTOCOL-APPLICATION PROCESSOR ASPECTS” and filed on May 16, 2024, which is expressly incorporated by reference herein in its entirety.

### TECHNICAL FIELD

The present disclosure relates generally to communication systems, and more particularly, to wireless communication in association with a low latency low loss scalable throughput (L4S) protocol.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or user equipment (UE) configured to obtain a first plurality of generated packets including information related to the L4S service and process, based on the information related to the L4S service, the first plurality of generated packets for transmission by the UE.

In an aspect of the disclosure, a method, a computer-readable medium, and an apparatus are provided. The apparatus may be a network device configured to some examples, a network device may be configured to include, in each received UL packet of a first plurality of received uplink (UL) packets, explicit congestion notification (ECN) information related to radio network delays and output, for a core network, the first plurality of received UL packets including the ECN information related to the L4S service.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating various latencies associated with an end-to-end system in accordance with some aspects of the disclosure.

FIG. 5 is a diagram and a graph illustrating concepts of L4S in accordance with some aspects of the disclosure.

FIG. 6 illustrates concepts related to congestion handling affecting queueing-related latency in accordance with some aspects of the disclosure.

FIG. 7 is a diagram illustrating elements of a cellular network or radio access network (RAN) that may be associated with additional delays not addressed by the L4S protocol described above in accordance with some aspects of the disclosure.

FIG. 8 is a diagram illustrating delays associated with communication over a RAN that might be experienced in accordance with some aspects of the disclosure.

FIG. 9 is a diagram illustrating aspects of the internet protocol (IP) packet and packet data convergence protocol (PDCP) packet data unit (PDU) processing in accordance with some aspects of the disclosure.

FIG. 10 is a diagram illustrating flow mapping and logical channel (LC) prioritization associated with multiple applications and multiple flows associated with the multiple applications in accordance with some aspects of the disclosure.

FIG. 11 is a diagram illustrating slice-specific flow mapping associated with multiple applications and multiple flows associated with the multiple applications in accordance with some aspects of the disclosure.

FIG. 12 is a diagram illustrating flow mapping associated with multiple applications and multiple flows associated with the multiple applications in accordance with some aspects of the disclosure.

FIG. 13 is a call flow diagram of a method of wireless communication in accordance with some aspects of the disclosure.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

### DETAILED DESCRIPTION

Some applications using wireless communication to communicate with a network may be more sensitive to increased latency than other applications. For example, extended reality (XR), virtual reality (VR), or time sensitive networking (TSN) applications may be sensitive to increased latency or mismatched latency between different types of data and/or feedback associated with the XR or VR application. In some aspects of wireless communication associated with the latency-sensitive applications, IP packets may be transmitted between a wireless device and an application server on a network. The IP packets may further be associated with a transmission control protocol (TCP). The TCP may implement and/or be associated with congestion algorithms for IP traffic being routed through an IP network including various intermittent nodes which may experience varying traffic loading and buffer management issues that may result in increased queuing delay or packet loss.

To address shortcomings of TCP congestion algorithms the L4S protocol may be implemented with some variations to the architecture of the TCP protocol and congestion management techniques. In some aspects, the L4S protocol may be backwards compatible with elements not supporting the L4S protocol. While the L4S protocol addresses the IP data transmission as well as the congestion aspects to improve the traffic flow key performance indicators (KPIs) in the IP Network, it may not address issues introduced by wireless communication and/or a radio access network (RAN). For example, additional delays and packet loss/recovery characteristics may impact the overall latency associated with application data. The additional delays and/or the packet loss/recovery characteristics may be related to aspects of a buffering policy at a network entity and/or UE, capabilities of the network entity and/or UE, and/or configuration parameters like a packet data convergence protocol (PDCP) discard timer from the transmission side, a PDCP reordering timer from a receive side, a radio link control (RLC) retransmission trigger, an RLC polling trigger, an RLC status trigger, a hybrid automatic repeat request (HARQ) configuration, as well as buffer overload policies.

Various aspects relate generally to enhancing and/or extending L4S traffic handling to provide the benefits of the L4S in view of the cellular environment to provide the overall end-to-end (E2E) data KPIs. Some aspects more specifically relate to treating L4S traffic differently in a radio environment (e.g., wireless communication) based on protocol and configuration aspects of the radio environment specific to technology and/or topology of the components of the radio environment. In some examples, a wireless device may be configured to obtain a first plurality of generated packets including information related to the L4S service and process, based on the information related to the L4S service, the first plurality of generated packets for transmission by the UE. In some examples, a network device may be configured to include, in each received UL packet of a first plurality of received UL packets, ECN information related to radio network delays and output, for a core network, the first plurality of received UL packets including the ECN information related to the L4S service.

Particular aspects of the subject matter described in this disclosure can be implemented to realize one or more of the following potential advantages. In some examples, by enhancing and/or extending L4S traffic handling, the described techniques can be used to address the queuing delay and buffer handling aspects to have enhanced E2E application level KPIs to improve the SLA aspects of the application (e.g., a user experience).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspects. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

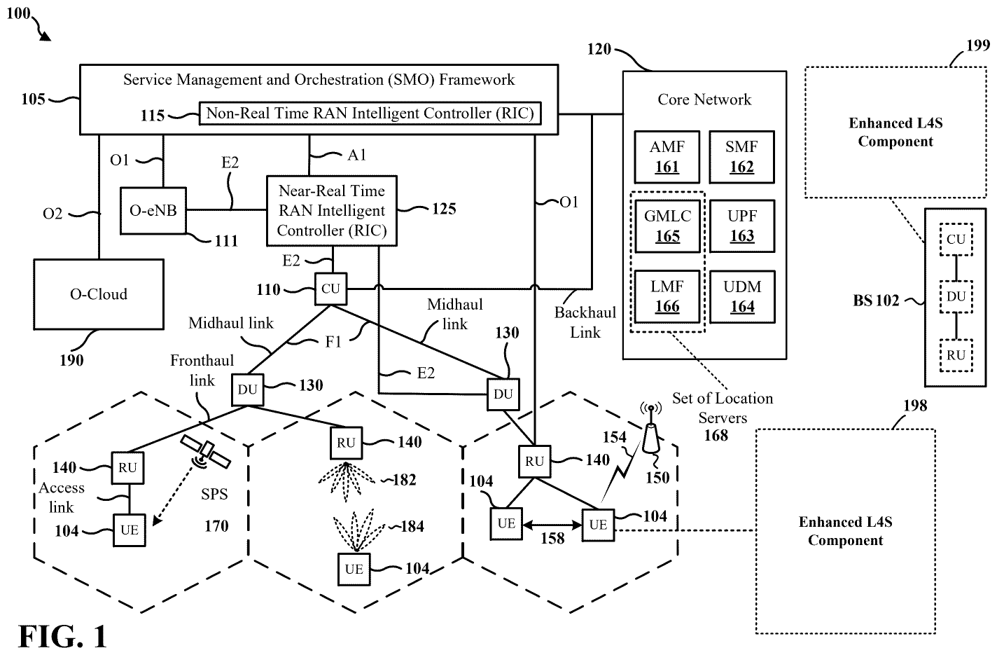

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an enhanced L4S component 198 that may be configured to obtain a first plurality of generated packets including information related to the L4S service and process, based on the information related to the L4S service, the first plurality of generated packets for transmission by the UE. In certain aspects, the base station 102 may have an enhanced L4S component 199 that may be configured to include, in each received UL packet of a first plurality of received UL packets, ECN information related to radio network delays and output, for a core network, the first plurality of received UL packets including the information related to the L4S service. Although the following description may be focused on 5G NR, the concepts described herein may be applicable to other similar areas, such as LTE, LTE-A, CDMA, GSM, and other wireless technologies.

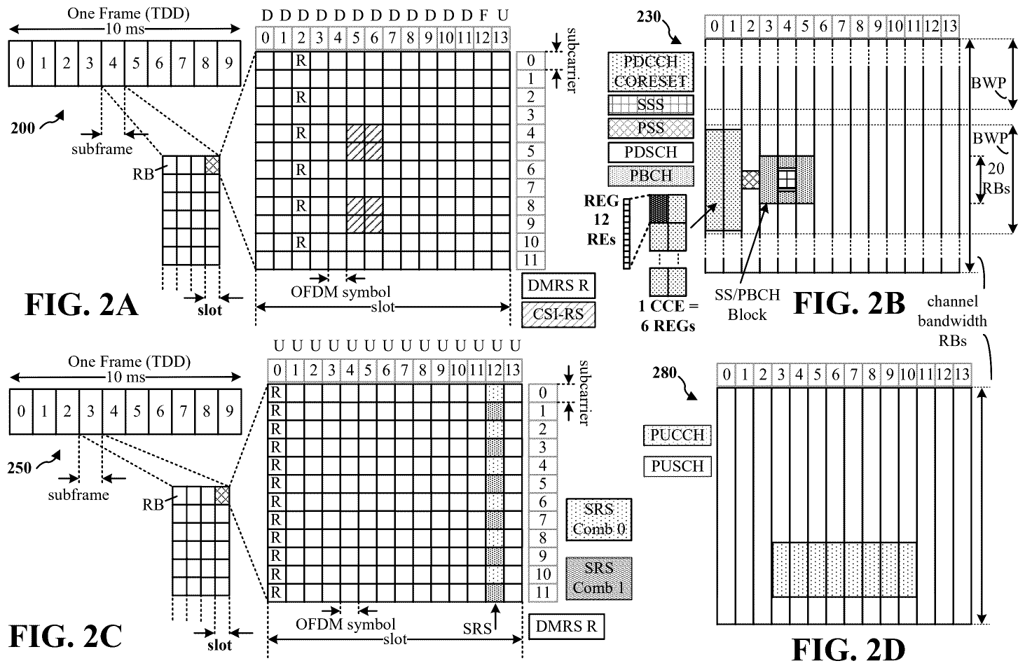

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3 and 4 are shown with slot formats 1 and 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2μ · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*15} kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

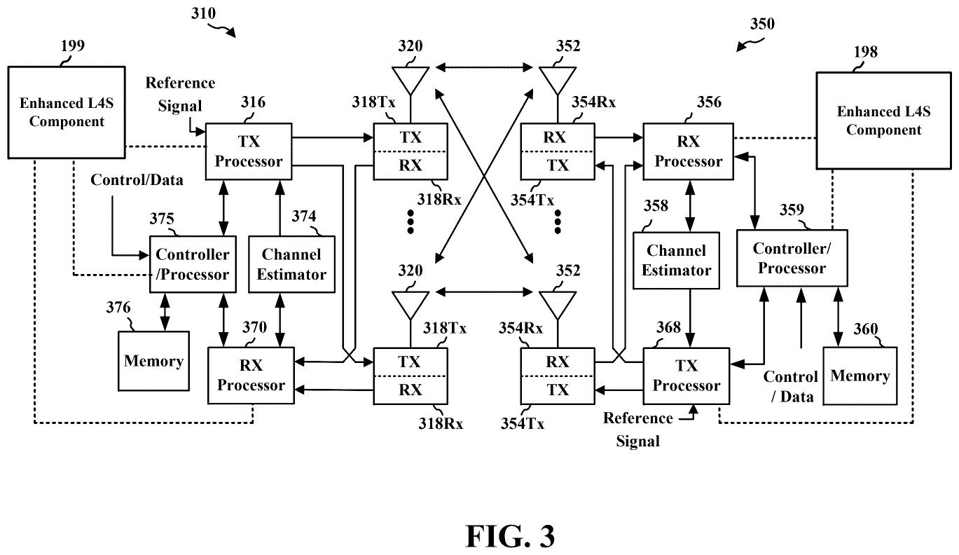

FIG. 3 is a block diagram of a base station 310 in communication with a UE 350 in an access network. In the DL, IP packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the enhanced L4S component 198 of FIG. 1.

At least one of the TX processor 316, the RX processor 370, and the controller/processor 375 may be configured to perform aspects in connection with the enhanced L4S component 199 of FIG. 1.

Classic data thresholds for user experience, in some aspects, may be based on, or associated with, defined KPIs linked to throughput, latency and/or packet loss. TCP may be associated with congestion algorithms that can be used for many applications and may handle traffic scaling aspects based on the KPIs (and/or other related metrics). There are many variants of TCP congestion algorithms to address different segments and market needs based on the traffic pattern and topology of a related network. In some aspects, congestion algorithms may be based on a user datagram protocol (UDP) such as QUIC and/or other algorithms to improve throughput and/or packet loss (e.g., solving a head-of-line blocking (HOLB) issue).

In some aspects, higher bandwidth links both at a backhaul and on radio networks may be used to address specific link issues. However, the nature of traffic for applications may vary, and congestion algorithms trying to adapt to the variable traffic may place a heavy demand to handle the latency and packet loss KPIs. In some aspects, the latency, which impacts the RTT, may result in dropped packet(s) indirectly based on the buildup of packets at the buffers at some link/point in an E2E network between an application server and a consumer.

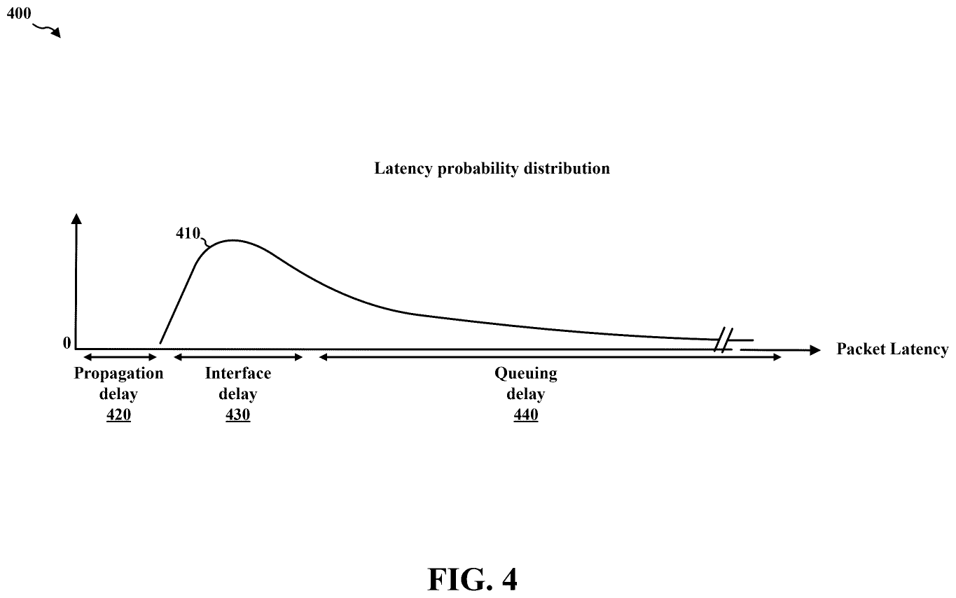

FIG. 4 is a diagram 400 illustrating various latencies associated with an end-to-end system in accordance with some aspects of the disclosure. Diagram 400 illustrates an example probability distribution of packet latency 410 for illustrative purposes and is not necessarily representative of a particular network. Diagram 400 illustrates that a propagation latency 420 (e.g., a latency and/or delay associated with a speed of light transmission over a radio network or fiberoptic network) may be associated with very low latency, such as 1 ms/200 km. An interface delay 430 (e.g., a latency and/or delay due to physical and MAC-layer implementation) may be relatively common and may be on the order of sub-millisecond to 100 ms. A queuing delay 440 (e.g., a latency and/or delay associated with queueing in network buffers) may be on the order of 0-1000 ms with the longer delays being less common but more disruptive. The information included in diagram 400 along with approaches used to address the different types of latency and/or delay may be summarized as in Table 2 below.

TABLE 2
Contributions to Latency and/or Delay

| Type | Latency/Delay | | Origin | Resolution |
|---|---|---|---|---|
| Propagation | 1 ms/200 km | | Speed of light | Move to edge cloud |
| delay | | | | |
| Interface | 0-100 | ms | Physical and | Improvements in |
| delay | | | MAC-layer | communication |
| | | | implementations | technology standards |
| Queuing | 0-1000 | ms | Queueing in | Avoiding and/or |
| delay | | | network buffers | managing queues |

A wireless communication network may support various types of wireless traffic. As an example of one type of traffic, XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The packets may vary in size and include varying amounts of data. XR traffic bursts may arrive at non-integer periods (i.e., in a non-integer cycle). The periods may be different than an integer number of symbols, slots, etc. Arrival times of XR traffic may vary. For example, XR traffic bursts may arrive and be available for transmission at a time that is earlier or later than a time at which a UE (or a base station) expects the XR traffic bursts. XR traffic may include multiple flows that arrive at a UE (or a base station) concurrently with one another (or within a threshold period of time). In an example, a first XR flow may include video data and a second XR flow may include audio data for the video data. In another example, the first XR flow may include intra-coded picture frames (I-frames) that include complete images and the second XR flow may include predicted picture frames (P-frames) that include changes from a previous image.

In an example of wireless communication between a UE, a base station, and a cloud server. In some aspects, the service provided to the UE may be an XR service or a cloud gaming service, and the associated traffic may be associated with a low latency. As an example, an uplink (UL) packet may include input information such as tracking information or user pose information for the XR service or inputs for the cloud gaming service. The cloud server may receive the UL packet and generate a DL packet based on the received UL packet. For example, the cloud server may receive the UL packet including the tracking/pose information for the XR service or inputs for the cloud gaming service, and generate the DL packet based on the received UL packet including the tracking/pose information for the XR service or inputs for the cloud gaming service.

In some aspects, the latency observed from the UE may be associated with a RTT between transmitting the UL packet and receiving the DL packet. That is, the network latency experienced at the UE may be determined based on a RTT between transmitting the UL packet including the tracking/pose information for the XR service or the inputs for the cloud gaming service and receiving the DL packet including the encoded data associated with the service provided to the UE.

One or more UEs may be associated with a different type of data (audio, visual, and/or tactile/haptic, etc.) and/or different data flows. As an example, one UE may correspond to VR glasses, and another UE may correspond to gloves associated with the same VR service as the VR glasses. The VR service may be for an immersive multi-modal VR application. The immersive experience may be based on data from multi-modal flows being received by the UE within a time period that meets a synchronization threshold. While each traffic flow may have different traffic patterns (e.g., periodicity) and/or QoS requirements (e.g., delay budget), the traffic may have inter-dependent delivery deadlines. For example, if a video frame is delivered but its associated audio frame is not delivered within a threshold number of msec, the overall user experience may be impacted. The tactile and multi-modal communication services may enable multi-modal interactions, combining ultra-low latency with extremely high availability, reliability, and/or security. An immersive user experience may be based on reception of the multi-modal flows (e.g., multi-modal data and/or traffic) by the UEs within synchronization thresholds. For example, audio data may be delayed by to related tactile/haptic data while tactile/haptic data may be delayed by up to 50 ms compared to related visual data.

For some applications run on wireless devices, such as XR or VR applications, latency may have significant effects on a user immersive experience. For example, haptic traffic may be associated with latency thresholds that are sub-5 ms, while the video gaming traffic may be associated with latency thresholds that are sub-30 ms. Similarly, a TSN may be associated with time critical operations (e.g., with a low latency threshold and/or maximum acceptable latency). In addition, when a user has mixed traffic with different latency sensitivity (e.g., audio/video/haptic data associated with low maximum latency thresholds and file upload/download as part of the applications usage) differential behavior of traffic management based on the traffic characteristics may be implemented to address latency issues.

To address the shortcomings of TCP congestion algorithms for IP traffic being routed through various intermittent nodes, which can experience varying traffic loading and buffer management issues that can result in increased queuing delay or packet loss, an L4S protocol provides some variations to the architecture of the TCP protocol and congestion management techniques, with a fallback mechanism to coexist with existing TCP/IP protocols rather than implementing a completely different protocol based on the support of the L4S protocol in, or by, the system. Aspects of the L4S protocol have been published by the internet engineering task force (IETF) as request for comments (RFC) 9330, 9331, 9332, among others.

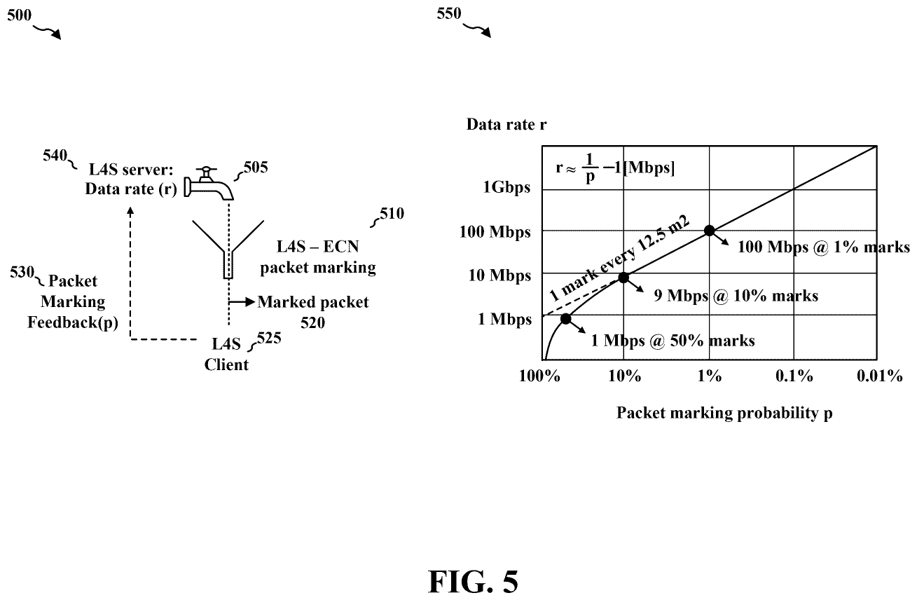

FIG. 5 is a diagram 500 and a graph 550 illustrating concepts of L4S that can be applied in accordance with some aspects of the disclosure. The L4S protocol uses a process that (at, for example, L4S-ECN packet marking 510) marks packets (IP or TCP/IP packets such as marked packet 520) with ECN information when there is congestion in a link. The packets may be transmitted from a transmitter 505 (or sender) such as an application server (or L4S server). In some aspects, the marking may be included in an IP-ECN field with four codepoints (e.g., a two-bit field) indicating one of four states where two different states may be used to indicate ECN-Capable Transport (ECT). For example, the IP-ECN field may indicate that the packet is not configured for L4S (e.g., “00” or “Not-ECT”), that the packet is configured for L4S (e.g., “01” /“ECT (0)” or “10” /“ECT (1)”), or that the packet is configured for L4S and that the packet experienced congestion (e.g., “11” or “congestion experienced (CE)”). In some aspects, the marking may occur whenever there is some buffer build up (e.g., congestion) in the link (e.g., an OTA link) at that link level (where different and/or parallel links may experience different levels of congestion). The marking, in some aspects, may be based on an elapsed time from a last marked packet (e.g., a last packet associated with a particular flow identified by the TCP/IP header) such that a packet is marked every X ms, where X may be a configurable parameter based on a desired maximum latency.

In some aspects, the marking enables a receiver (or an L4S client at the receiver 525) to understand how many packets experience queuing issues and/or an extent of latency introduced by queuing issues. Based on the number of marked packets, the receiver (the L4S client at the receiver 525) may determine information regarding an aggregated ECN and provide the aggregated ECN as feedback 530 to a transmitter to adapt (e.g., to scale) the transmission rate at the transmitter 505 to avoid buffer buildup. In some aspects, the adaptation and/or scaling at the transmitter 505 may be based on a data rate 540 (e.g., the rate at which the link experiencing congestion and/or buffer buildup) implied by, or calculated from, the feedback 530. For example, graph 550 illustrates that for packets marked at regular intervals, feedback related to the probability (p) of marking may be used to determine a data rate (r) at the link.

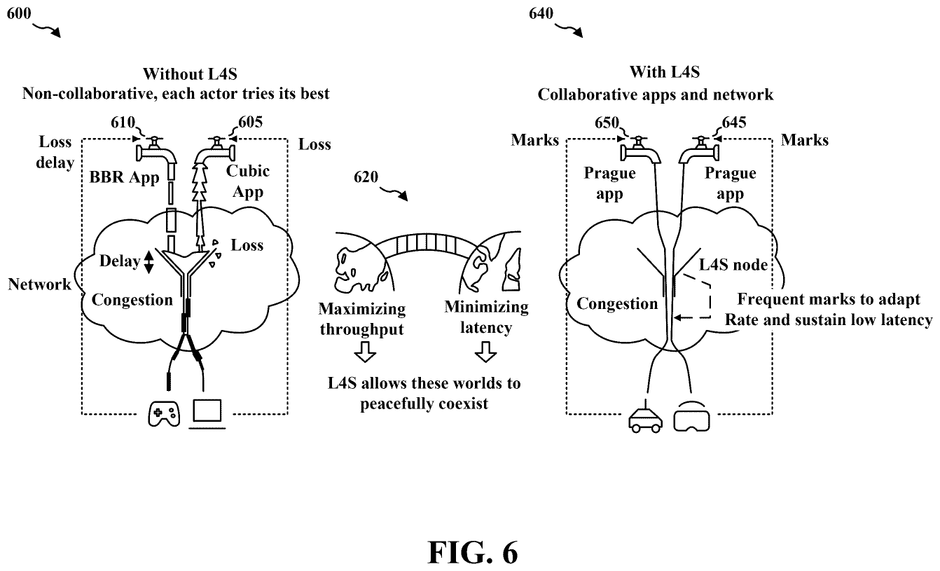

FIG. 6 illustrates concepts related to congestion handling affecting queueing-related latency in accordance with some aspects of the disclosure. Diagram 600 illustrates that without implementing L4S, other congestion handling techniques implemented by independent transmitters (e.g., a first transmitter 605 implementing CUBIC congestion control and a second transmitted 610 implementing bottleneck bandwidth and round-trip propagation time (BBR) congestion control) may independently attempt to adjust data rates based on feedback related to packet loss and/or delay information, but that they may experience varying data rates and still experience delays and/or loss. Diagram 620 conceptually illustrates the two “worlds” or concerns of throughput maximization and latency minimization being bridged by L4S, e.g., that L4S maximizes throughput for the path used by the IP packets while minimizing latency for those IP packets. Diagram 640 illustrates that based on information regarding marked packets, two independent transmitters (e.g., transmitter 645 and transmitter 650 both implementing an L4S based congestion control such as the Prague congestion control) may independently adjust a packet transmission rate to maintain a “clear” buffer that does not experience queueing based latency. As both transmitters receive feedback based on the same packet marking, the independent rate scaling and/or adjustment may be coordinated without direct communication between the independent transmitters.

As illustrated in FIGS. 5 and 6, low latency, in some aspects of L4S, may not be provided by the network. Instead, the latency reduction results from the careful behavior of the scalable congestion controllers used by the L4S transmitters/senders. The transmitter and/or sender, in some aspects, uses the ECN protocol, such that it signals the start of queue growth without the smoothing delay typical of Classic AQMs (e.g., such that the start of the queue growth is signaled “immediately” or within a much shorter time than other congestion control protocols). Because ECN support is the mechanism used for L4S, senders use the ECN field as the protocol that allows the network to identify which packets are L4S and which are classic and/or not-ECT. A sending host (or transmitter such as an application server) needs to distinguish L4S and classic/not-ECT packets with an identifier so that the network can classify them into their separate treatments. As described above, the identifier may be included in an IP-ECN field (e.g., a “11” /“CE,” “10” /“ECT (0)” or “01” /“ECT (1)” codepoint).

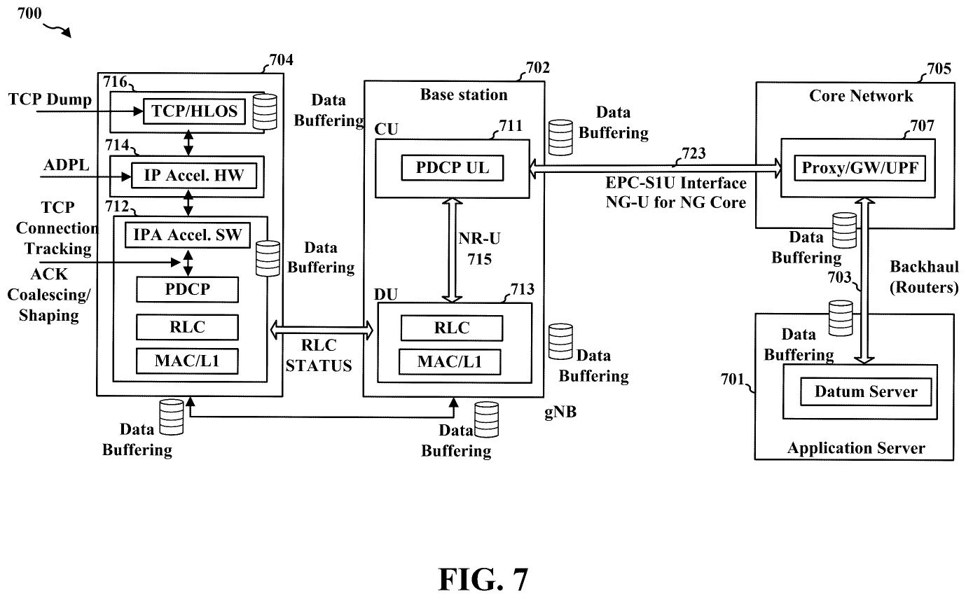

FIG. 7 is a diagram 700 illustrating elements of a cellular network or RAN that may be associated with additional delays not addressed by the L4S protocol described above, and which are addressed in accordance with some aspects of the disclosure. For example, the L4S protocol described above addresses congestion associated with IP packet transmission to improve the traffic flow KPIs in an IP Network. However, the described L4S protocol does not address “last mile” issues that arise in a cellular network. Diagram 700 illustrates an application server 701 that may provide application data (e.g., IP packets carrying application data) over a backhaul connection 703 to a core network 705. If the backhaul connection is based on an IP network or TCP/IP protocol, the congestion arising at queues associated with the application server 701, the backhaul connection 703, or the core network 705 may be addressed by L4S protocol described in connection with FIGS. 5 and 6. Accordingly, while in some aspects, the backhaul is continuing to move the data towards the RAN (or from the RAN) with enough link capabilities and/or capacity, because the RAN may transmit and/or forward the IP packets using PDCP, the L4S protocol may not address the last mile issue of buffering at radio ingress/egress levels between the RAN node and a UE 704.

The UE 704 may include a modem 712, an application processor 716, and an interconnect 714 (representing one or more interconnects) that may provide communication between the application processor 716 and the modem 712. The modem 712, the interconnect 714, and the application processor 716 may be provided by different vendors or by a same vendor. For downlink transmissions, the data path may include a first portion from the application server 701 to, for example, a UPF 707 of a core network 705 and/or the radio network, a second portion from the UPF 707 to a base station 702 (e.g., a gNB) that may be IP-based without flow control. Accordingly, data moves freely based on routing rules and the link capacity, and IP packets may not be expected to be dropped. The L4S protocol (and/or other congestion prevention protocols) may address queueing delay increases on the first two portions of the path (e.g., 703 and 723).

As the IP Packet enters into a RAN entity (e.g., the base station 702), the IP packet may move through various radio protocols (e.g., PDCP). Accordingly, IP packets may not be modified within radio protocol layers in accordance with the L4S protocol aspects. For example, as the IP Packet enters the CU 711 (or a PDCP component of the CU 711 and/or an associated input queue), the packet may be encoded as part of the PDCP PDU (e.g., a PDU including a PDCP header and a PDCP service data unit (SDU) that may be the original IP Packet). Additionally, the CU 711 (or the PDCP component of the CU 711) may perform ciphering and integrity protection to ensure the security aspects. In order to maintain the integrity protection, the PDCP contents (e.g., the PDCP SDU or the IP packet included in the PDCP PDU) may not be modified. Accordingly, L4S-based marking of the IP packet is not updated and/or implemented for the PDCP PDU in transit from the CU 711 to the UE 704 (or the modem 712 of the UE 704) without introducing additional ciphering and integrity protection operations that may not be supported or may introduce additional latency and/or overhead. The inability to modify the PDCP contents on the radio links (e.g., the links between the CU 711 and a DU 713 or between a DU 713 and the UE 704), in some aspects, may be implemented to avoid wide range of security issues and man-in-the-middle attacks.

In some aspects, the PDCP layer which is implemented in the CU 711, may move packets over the wireless link 715 (e.g., a NR in unlicensed spectrum (NR-U) link) to DU 713 for RLC level protocol handling and subsequent MAC scheduling to transmit OTA. The wireless link 715, in some aspects, may work based on the general packet radio service (GPRS) tunneling protocol of the user plane (GTP-U) with “status-retransmission” to ensure all the packets are successfully received at the DU 713. In some aspects, there may be additional delays and packet loss/recovery characteristics (RLC ARQ, HARQ ReTx) which may impact the overall latency from the perspective of the application data.

For UL transmissions, in some aspects, an application processor 716 (or application) may send data to a modem 712 through various interconnect mechanisms and/or data exchange paths (e.g., an interconnect 714 that may include one or more of shared memory, universal serial bus (USB), peripheral component interconnect express (PCIe), hardware (HW) accelerators, etc.). Once the data enters a PDCP Queue of the modem 712, in some aspects, it may be reported as part of the data volume reporting through MAC BSR to the network in association with a request for a UL grant (e.g., a request for a resource allocation for transmitting the UL data). In some aspects, might be through a scheduling request (SR) procedure or a RACH procedure based on the UE internal state.

After sending the BSR successfully, based on the radio conditions and network scheduling policy for the UE 704, a grant may be issued to each UE (including UE 704), and data may be transmitted, where the process of requesting and receiving the UL grant may impact the overall delay and packet loss associated with the traffic. As the IP Packets enter the PDCP input queue of the modem 712, in some aspects, it may be encoded as part of the PDCP PDU as described above in relation to the PDCP implemented at the base station 702 (and the CU 711). As described above, the PDCP processing, in some aspects, may include ciphering and integrity protection to ensure the security of the data (e.g., the IP packet and/or PDCP SDU) which precludes further modification of the data. Accordingly, L4S-based marking of the IP packet may not be updated and/or implemented for the PDCP PDU in transit from the UE 704 (or the modem 712 of the UE 704) to the CU 711 without introducing additional ciphering and integrity protection operations that may not be supported or may introduce additional latency and/or overhead. As for the DL data transmission, in some aspects, there may be additional delays and packet loss/recovery characteristics (RLC ARQ, HARQ ReTx), which impact the overall latency for application data (as experienced at the application processor 716 (or application).

The delays discussed above may result in packet loss based on various aspects of the buffering policy at the base station and/or the UE and their capabilities. The delays discussed above may further result in packet loss based on configuration parameters like a PDCP discard timer at the transmitter (e.g., the UE 704 or the base station 702), a PDCP reordering timer at the receiver (e.g., the UE 704 or the base station 702), an RLC retransmission trigger, an RLC polling trigger, an RLC status trigger, a HARQ configuration, as well as buffer overload policies.

As the IP aspects of the packet cease after the PDCP PDU encoding (due to cipher/integrity aspects), even with the additional queueing latency issues identified, packets cannot be modified/marked with ECN in association with standard L4S. As many of the deployments in, or of, the radio network and/or cellular environment use the PDCP in-sequence delivery, there may be at least two different ways for the packets to experience higher delay. First, on a given radio link, apart from the packets which are going through retransmission and experiencing an associated higher latency, all other packets which are successfully received and waiting in the PDCP reordering queue will experience the additional latency. For example, related packets will experience worst case latency of the last packet reception to enable the in-sequence delivery or timer reordering expiry. These delays, in some aspects, may be due to radio link level block error rate (BLER), component carrier (CC) level BLER, slot level BLER, or specific to an MCS level. In dual connected (DC) mode of operation (NR-DC and/or E-UTRA-NR DC (EN-DC)), as different PDCP packets are transmitted/received on different radio connections or links (LTE vs. NR, FR1 vs. FR2), associated additional delay/loss also can contribute to a larger number of packets being in the waiting mode at PDCP reordering level.

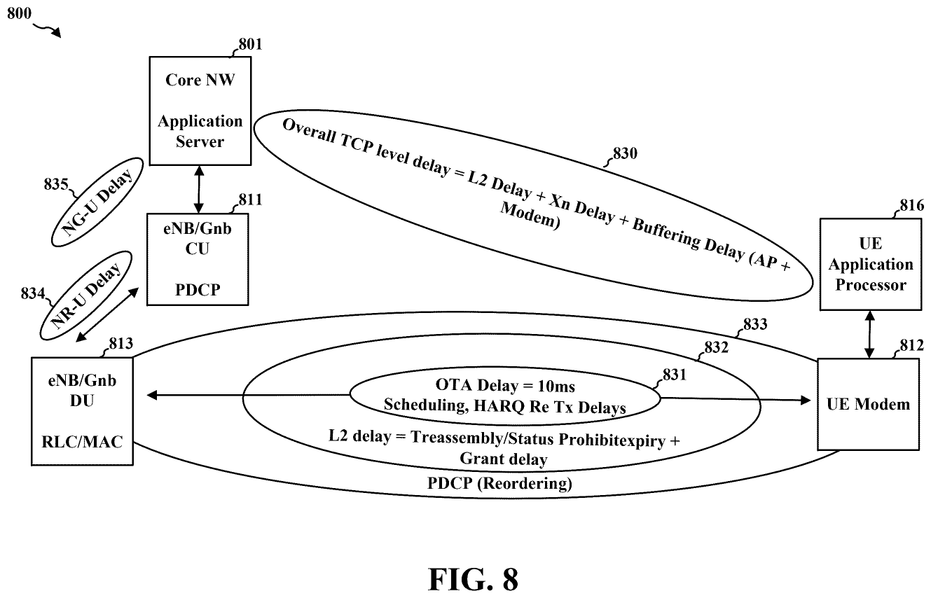

FIG. 8 is a diagram 800 illustrating delays associated with communication over a RAN that might be experienced in accordance with some aspects of the disclosure. As discussed in relation to FIG. 7, diagram 800 illustrates a UE application processor 816 using a UE Modem 712 to transmit IP packets associated with an application (e.g., an XR, VR, or other time-sensitive application) to an application server/core network 801 via a DU 813 and a CU 811 (e.g., associated with an aggregated or disaggregated base station). As illustrated in diagram 800, the E2E communication between the application server/core network 801 and the UE application processor 816 may experience a delay and/or latency 830. The delay and/or latency 830 may be based on the factors discussed above in relation to FIGS. 4 and 7, such as an OTA delay 831 based on scheduling and retransmission delays, L2 delays 832, and PDCP (reordering) delays 833, NR-U delays 834, and next generation user plane (NG-U) delays 835.

The different delays illustrated in FIG. 8 (and associated KPIs for the data transmission), in some aspects, may be based on, or impacted by, various configurations and implementation-specific parameters. For example, an error correction technique applied at the application (e.g., the XR or VR application) and/or quality of service (QOS) characteristics (a packet error rate (PER), a PDU set error rate (PSER), a packet delay budget (PDB), a PSDB, a maximum bit rate (MBR), a guaranteed bit rate (GBR), an allocation and retention priority (ARP), etc.) associated with the application may impact the delay and/or KPIs. In some aspects, the configuration and/or specific parameters associated with a TCP slow start, an ACK frequency, a number of flows, window management, window scaling, and/or the capabilities of a core processor may affect the delay and/or KPIs. PDCP protocol configurations and/or specific parameters, e.g., associated with a Treordering, a memory flush, a flow control queue, dropped (e.g., “DROPPED”) packets, mismatch delays due to different RATs (e.g., LTE vs. NR scheduling delays), ciphering jumps, etc., may also impact the delays and/or KPIs.

Delays and/or KPIs may also be impacted by configurations and/or specific parameters associated with RLC (e.g., an RLC reassembly timer, reordering, status prohibit, status period, polling, RLC retransmission, truncation, etc.). MAC layer configurations and/or specific parameters related to MAC HARQ, MAC SR, MAC BSR, discontinuous reception (DRX), etc. may also impact delay and/or KPIs. At the the PHY layer, the configurations and/or specific parameters associated with a HARQ, a BLER, a residual BLER, an MCS, a physical resource block (PRB), a CQI, a redundancy version (RV) level, a frame number and/or slot level, a DRX, a timing advance (TA), a received signal strength indicator (RSSI), a reference signal received power (RSRP), a reference signal received quality (RSRQ), a RAT, a CC, HARQ, etc. may further impact the delay and/or KPIs.

In some aspects, a transmitting PDCP entity may be configured with a discard timer (e.g., discardTimer). The discard timer, in some aspects, may be configured for data radio bearers (DRBs). The duration of the timer, in some aspects, may be configured by upper layers. In the transmitter, a new timer may be started upon reception of an SDU from an upper layer. A receiving PDCP entity, in some aspects, may be configured with a t-reordering (or Treoredering). The duration of the timer (e.g. t-reordering or Treordering) may be configured by upper layers, e.g., except for the case of NR sidelink communication. For NR sidelink communication, the t-Reordering timer may be determined by the UE implementation. The t-reordering timer is used to detect loss of PDCP Data PDUs. In some aspects, if a t-reordering timer is running, an additional t-reordering will not be started such that one t-reordering per receiving PDCP entity is running at a given time.

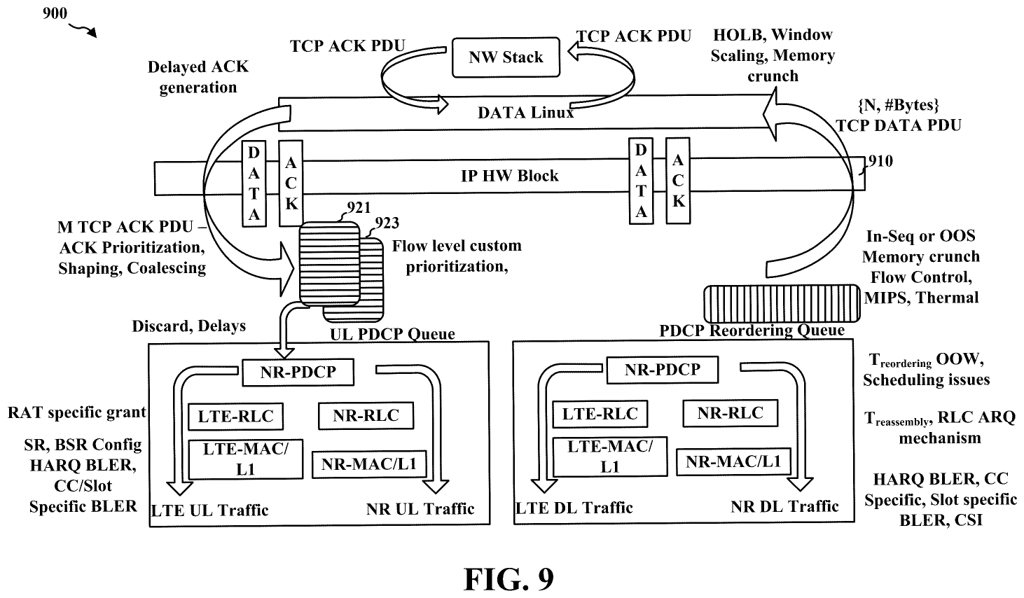

FIG. 9 is a diagram 900 illustrating aspects of the IP packet and PDCP PDU processing in accordance with some aspects of the disclosure. Diagram 900 illustrates that an IP HW block 910 (e.g., in an interconnect between an application server and a modem) may treat L4S packets differently from non-L4S packets. For example, the IP HW block 910, in some aspects, may segregate L4S and non-L4S packets/PDUs into separate PDCP queues (e.g., a first PDCP queue 921 for L4S packets/PDUs and a second PDCP queue 923 for non-L4S packets/PDUs). The packets in the different PDCP queues 921 and 923, in some aspects, may then be processed differently to account for the extension and/or enhancement of the L4S protocol as discussed below. In some aspects, the incoming data may be associated with a DC (NR-DC or EN-DC) and the IP HW block 910 that may combine DL packets into a single packet or combine UL packets. In some aspects, the IP HW block 910 may further perform ACK shaping, ACK coalescing, and ACK prioritization. The ACK shaping, coalescing, and prioritization for UL, in some packets may be L4S-aware such that L4S packets may be treated differently from non-L4S packets (may have ACK coalescing or skipping omitted to maintain L4S information such as ECN information). While we are doing all this business, attention is given to the L4S traffic associated with the uplink transmission(s). We can separate the L4S traffic versus the non-L4S traffic so that we can do things differently.

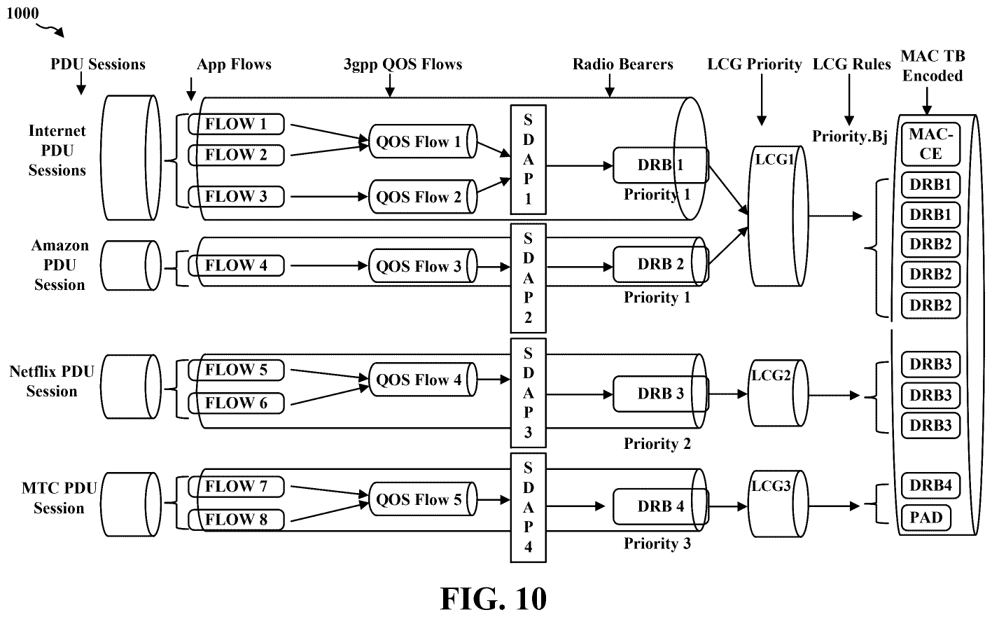

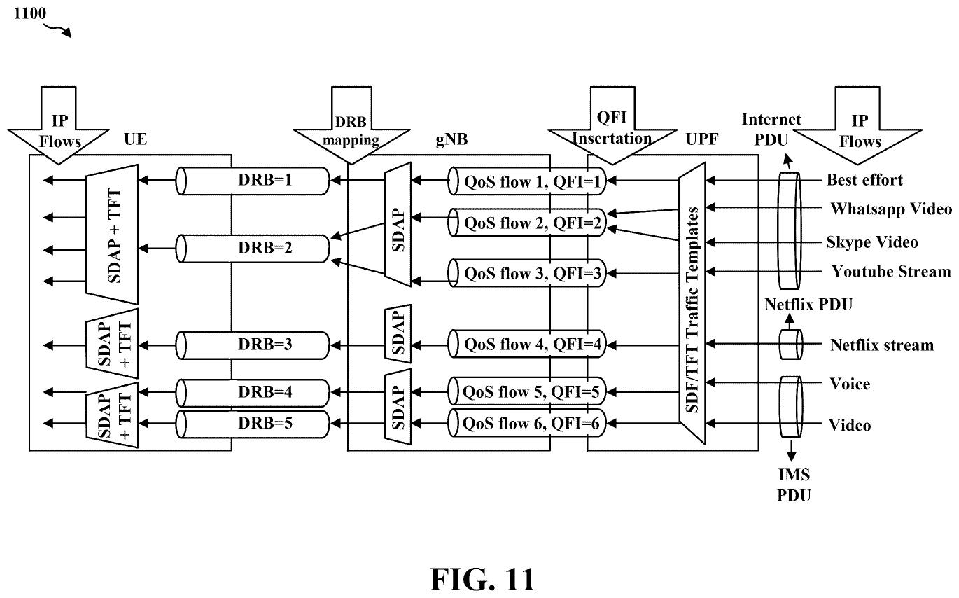

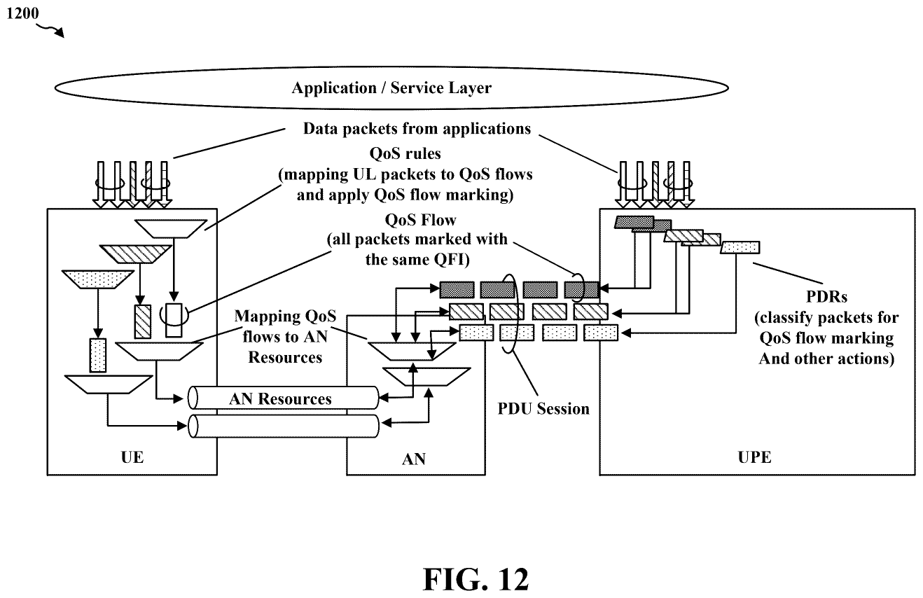

FIG. 10 is a diagram 1000 illustrating flow mapping and logical channel (LC) prioritization associated with multiple applications and multiple flows associated with the multiple applications in accordance with some aspects of the disclosure. The flow mapping illustrated in diagram 1000 may be performed at a UE or at a network device. FIG. 11 is a diagram 1100 illustrating slice-specific flow mapping associated with multiple applications and multiple flows associated with the multiple applications in accordance with some aspects of the disclosure. For example, diagram 1100 illustrates that multiple flows may be mapped to one RB and that multiple RBs may be mapped on a same PDU session (associated with default and optional dedicated bearers (DRBs)). In some aspects, one SDAP enetity may be associated with each PDU session and different PDU sessions may be associated with different slices. FIG. 12 is a diagram 1200 illustrating flow mapping associated with multiple applications and multiple flows associated with the multiple applications in accordance with some aspects of the disclosure. Diagram 1200 illustrates that, in some aspects, various QoS flows may be mapped with different QoS thresholds/characteristics across the bearers. In some aspects, whether the bearers are part of a single slide or different slices may introduce additional levels of distinction in supporting E2E resource management to meet service level agreements (SLAs).

Various aspects relate generally to enhancing and/or extending L4S traffic handling to ensure the benefits of the L4S in the cellular environment to provide the overall end-to-end data KPIs. Some aspects more specifically relate to treating L4S traffic differently in a radio environment (e.g., wireless communication) based on protocol and configuration aspects of the radio environment specific to technology and/or topology of the components of the radio environment. Various aspects further relate more specifically to UL transmissions from a UL application processor and/or modem of a UE and network UPF processing of the UL transmissions. In some examples, a wireless device may be configured to obtain a first plurality of generated packets including information related to the L4S service and process, based on the information related to the L4S service, the first plurality of generated packets for transmission by the UE. In some examples, a network device may be configured to include, in each received UL packet of a first plurality of received UL packets, ECN information related to radio network delays and output, for a core network, the first plurality of received UL packets including the ECN information related to the L4S service.

Particular aspects of the subject matter described in this disclosure can be implemented to realize one or more of the following potential advantages. In some examples, by enhancing and/or extending L4S traffic handling, the described techniques can be used to address the queuing delay and buffer handling aspects to have enhanced E2E application level KPIs to improve the SLA aspects of the application (e.g., a user experience).

In some aspects, an application processor subsystem at a UE may determine not to combine L4S data packets with ECN information (e.g., not coalesce multiple UL packets such as in ULSO) when the different types of packets are moved between entities of the UE. For example, the application processor may refrain from combining L4S data packets with ECN information (whether an indication that the packet is an L4S data packet and/or that congestion has been experienced) with other L4S data packets in a same flow rather than combining such packets to accommodate a larger MTU size for the OTA transmission. For example, L4S packets with ECN may not be combined with other L4S packets. In some aspects, one flow is either L4S or non-L4S, without combining between L4S and non-L4S traffic.

In some aspects, when aggregated ECN feedback information is transmitted in UL through TCP ACK (or other protocol feedback), the UE may not drop the TCP ACK packet to save UL bandwidth in the application processor.

In some aspects, the L4S traffic may use an exclusive data path through a reserved channel in a hardware path of the UE. The L4S traffic may be marked with special headers during the exchange on interface (PCIe or USB or QMAP). The L4S traffic might not go through aggregation or accumulation triggers.

In some aspects, based on an UL queue built up in the modem (e.g., as represented by a PDCP UL queue, a total amount of data yet to be transmitted for the first time, or a total amount of data yet to be successfully acknowledged by receiver), the UE (e.g., the application processor of the UE) may start marking the L4S ECN information for the given flow, where coordination is possible. In some aspects, based on the available queue in the modem and the current radio data rate, the UE (e.g., the application processor of the UE) may control the amount of L4S traffic vs. non-L4S traffic and mark the L4S packets appropriately with ECN information. In some aspects, the UE (e.g., the application processor of the UE) may mark the packets over the interconnect with L4S ECN for a given flow, such as on PCIe or USB link or through a data accelerator such as an IP hardware accelerator.

Some aspects may be applied for PDU set based configurations (e.g., towards XR), based on PDU set marking across packets and defined/configured PDU set metrics (e.g., PSDB, PSER, PSI, PSIHI). In some aspects, the UE (e.g., the application processor of the UE) may mark specific packets with ECN information, such as when PSI based PDU discard is exercised with network-based congestion indication. For example, an I-frame may be configured with a higher priority compared to a P-frame, and the P-frame may be dropped during an explicit congestion notification from the network. In some aspects, the UE (e.g., the application processor of the UE) may mark specific packets with ECN information, such as when specific packets are lost in the PDU Set though PSIHI indicated all packets are not necessary. PSIHI indicates whether all the packets are needed or not in the PDU Set for successful decoding based on level of FEC techniques (redundant packets along with systematic packets). In some aspects, multi-modal association between flows (Video, Audio, Haptic) may provide a combined immersive experience to an application user, when one flow gets delayed due to HW encoders or accelerators-other associated flows can be marked with ECN. In some aspects, during a congestion indication from the network, ECN marked packets may be set as PSI HIGH at the application processor level to ensure they are not dropped in the uplink at the modem level.

In some aspects, at the UPF, the network may mark the packets that are already received in the PDCP and have gone through a reordering queue (e.g., with in-sequence delivery configuration), and are waiting for earlier PDCP PDUs to meet the in-sequence delivery. In some aspects, all of the packets will experience a worst-case delay due to (1) a last packet that is received to unblock the in-sequence delivery, (2) due to a timer reordering expiry at a receiving PDCP module, or (3) due to a transmitter sending the PDCP Control PDU with the info of dropped packets.

In some aspects, the packets that are received in the UPF may be marked, e.g., if there is identified packet loss over the NG-U GTP-U based link as there is no retransmission or buffer-based flow control.

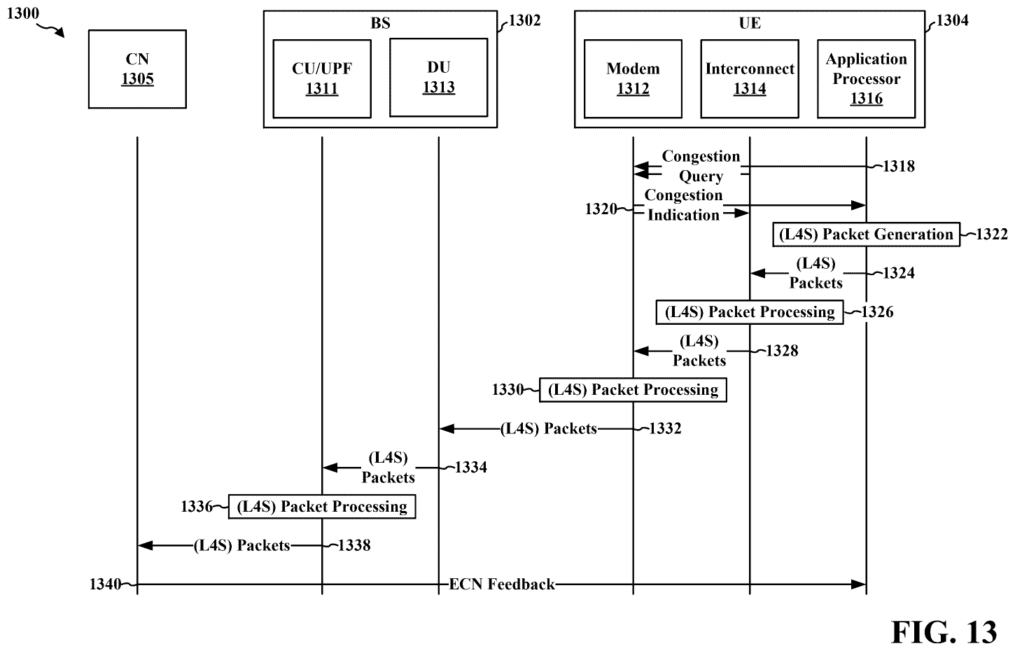

FIG. 13 is a call flow diagram 1300 of a method of wireless communication in accordance with some aspects of the disclosure. The method is illustrated in relation to a core network 1305, a base station 1302 (e.g., as an example of a network device or network node that may include one or more components such as CU 1311 (e.g., a CU implementing a UPF) and DU 1313 of a disaggregated base station) in communication with a UE 1304 (e.g., as an example of a wireless device that may include components such as an application processor 1316, an interconnect 1314, and a modem 1312). The functions ascribed to the base station 1302, in some aspects, may be performed by one or more components of a network entity, a network node, or a network device (a single network entity/node/device or a disaggregated network entity/node/device as described above in relation to FIG. 1). Similarly, the functions ascribed to the UE 1304, in some aspects, may be performed by one or more components of a wireless device supporting communication with a network entity/node/device. Accordingly, references to “transmitting” in the description below may be understood to refer to a first component of the base station 1302 (or the UE 1304) outputting (or providing) an indication of the content of the transmission to be transmitted by a different component of the base station 1302 (or the UE 1304). Similarly, references to “receiving” in the description below may be understood to refer to a first component of the base station 1302 (or the UE 1304) receiving a transmitted signal and outputting (or providing) the received signal (or information based on the received signal) to a different component of the base station 1302 (or the UE 1304).

In some aspects, the method may be associated with a latency-sensitive application such as an XR or VR application that may be associated with multiple types of data and/or flows. For example, an XR application may be associated with video data, audio data, and haptic data (feedback) where each may be associated with different latency thresholds for a seamless (or acceptable) user experience. In some aspects, the application processor 1316 or the interconnect 1314 (or a related component) may output, and the modem 1312 (or a related component) may obtain, a query 1318 regarding a congestion experienced at the modem 1312. The query 1318 may be output based on enabling an (enhanced) L4S service for one or more applications executing on the UE 1304. The modem 1312 may output, and the application processor 1316 or the interconnect 1314 may obtain, congestion indication 1320. The congestion indication 1320, in some aspects, may be output based on the query 1318 or it may be output based on a triggering event such as failure to transmit (e.g., based on a dropping criteria and/or timer expiration) a threshold number of packets, PDUs, and/or PDU sets, where the threshold may be set to 0.

The congestion indication 1320, in some aspects, may be associated with a first PDU set associated with PDU set metrics including one or more of a PSDB, a PSER, a PS importance (PSI), or a PDU set integrity handling indicator (PSIHI), and the congestion indication 1320 may include at least one of a first number of PDU sets associated with the first PDU set dropped due to a first congestion (e.g., meeting a first congestion-based trigger), a second number of PDUs dropped in one or more PDU sets associated with the first PDU set (e.g., other PDU sets in and/or associate with a same flow), a second congestion experienced by a third set of PDU sets associated with the first PDU set (e.g., other PDU sets in and/or associated with different flows that are associated with a same and/or related application), a third congestion experienced by a network associated with the first PDU set (e.g., indicated by a network congestion indication). In some aspects congestion indication 1320 may include information regarding one or more of a first amount of data in a queue for transmission, a data transmission rate (e.g., the rate at which data is transmitted from the UE 1304, the modem 1312, and or the queue), a second amount of data to be transmitted for a first time, a third amount of data not yet acknowledged to be received successfully, a scheduling delay at the UE, a delay associated with re-transmission by the UE 1304, a PDCP reordering delay, a timer based delay at the UE, a HARQ based delay, or an RLC ARQ based delay.

In some aspects, the information regarding one of the first, second, or third amounts of data and the data transmission rate may be used to determine an expected value for a component of latency related to queueing and/or buffering. For example, an indication that the buffer and/or queue includes 1 Mb of data may be associated with a non-negligible delay at a first data rate (e.g., 1 Kbps) while at a second data rate (e.g., 1 Gbps) the same amount of data in the buffer and/or queue may be associated with a negligible delay.

In some aspects, based on the congestion indication 1320, the application processor 1316 may generate and/or process, at 1322, L4S packets (or L4S-enabled packets) for a first application and/or a first flow associated with the first application (e.g., a flow associated with video data for the first application). In some aspects, the processing at 1322 may include updating ECN associated with one or more of the generated L4S packets based on the one or more radio characteristics and/or based on PDU handling at the UE 1304 indicated in congestion indication 1320. The L4S packets, in some aspects, may be associated with an L4S PDU and/or an L4S PDU set, e.g., for a PDU set based application such as some XR applications. The application processor 1316, in some aspects, may also generate non-L4S packets (or non-L4S PDUs or PDU sets) at 1322 for a second application and additional L4S packets for additional (related) flows of the first application (e.g., a flow associated with audio and/or haptic data for the first application) or for other applications for which L4S has been activated and/or enabled.

The L4S packets generated at 1322, in some aspects, may include information related to the L4S service. The information related to the L4S service, in some aspects, may include at least one of an ECT indication that the generated packet is associated with the L4S service or a CE indication that the generated packet has experienced congestion. In some aspects, the L4S packets may be identified by one of three codepoints and/or values in an IP-ECN field in an IP header while the non-L4S packets may be identified by a fourth codepoint and/or value in the IP-ECN field in the IP header. For example, the L4S packets may include a “01” /“ECT(0)” or “10” /“ECT(1)” value/codepoint in the IP-ECN field in the IP header indicating that the packet is configured for L4S, or a “11” /“CE” value/codepoint in the IP-ECN field in the IP header indicating that the packet is configured for L4S and that the packet experienced congestion while the non-L4S packets may include a “00” /“non-ECT” value/codepoint indicating that the packet is not configured for L4S.

The generation and/or processing of the L4S packets at 1322, in some aspects, may include controlling, based on the information regarding the radio characteristics of the first plurality of generated packets included in the congestion indication 1320, a proportion of L4S service packets in relation to non-L4S service packets. In some aspects, the generation and/or processing of the L4S packets at 1322 may include controlling, based on the information regarding the radio characteristics of the first plurality of generated packets included in the congestion indication 1320, a proportion of L4S service packets marked as experiencing congestion in relation to L4S service packets not marked as experiencing congestion. For example, the number of the packets generated at 1322 that include a CE codepoint (e.g., “marked” packets) versus the number of packets generated at 1322 including an ECT(0) or ECT(1), may be based on the information included in the congestion indication 1320. For example, based on a projected latency introduced by buffer and/or queue buildup, the application processor 1316 may mark a percentage of the L4S packets, where the percentage may be based on, or associated with, a corresponding throughput, data rate, or other latency-related characteristic.

In some aspects, updating ECN associated with one or more of the generated L4S packets based on the PDU handling at the UE 1304 indicated in congestion indication 1320 may include marking one or more packets of a PDU set based on a PDU set importance (PSI) based discard at the UE. The processing at 1322 (or similarly at 1326 below), in some aspects, may include updating one or more PDU set characteristics. The PDU set related characteristics (e.g., a PSI) may be set for the L4S packets and/or PDUs in order to make it less likely that the packets and/or PDUs carrying ECN information will be dropped and/or lost. For example, a PSI may be set to “high” for PDUs carrying ECN information.

In some aspects, the L4S packets generated at 1322 may include at least one feedback packet (e.g., a TCP ACK or feedback for another protocol) and the at least one feedback packet may include aggregated ECN feedback information for consumption at a receiving device (e.g., where the receiving device originally transmitted, or was a source of, the ECN being aggregated). For example, the application processor 1316 (or other component of the UE 1304) may identify a number or proportion/percentage of received L4S packets including a CE indication and, based on the received number or proportion/percentage, identify a measure of congestion, a value for throughput scaling, a maximum data rate supported by the link, or some other value to be reported to the transmitting application. The application processor 1316 (or other component of the UE 1304) may include the identified value as aggregated ECN feedback in a TCP ACK (e.g., in a TCP header).

The application processor 1316 may output, and the interconnect 1314 may obtain, the set of packets 1324 (including the L4S packets and the non-L4S packets) generated at 1322. In some aspects, generating the L4S packets and/or outputting the L4S packets may be performed differently from the non-L4S packets. For example, non-L4S packets may be coalesced and/or combined into PDUs including multiple IP packets while for L4S packets the coalescing and/or combination may be skipped and/or omitted to maintain the information communicated by the percentage of marked L4S packets (e.g., IP packets including the CE codepoint). Coalescing of packets may be performed at various components of the UE, e.g., at an application processor or an interconnect, among other examples. Accordingly, the application processor 1316 may, as part of generating and/or processing the L4S packets at 1322 in some aspects, provide the L4S data packets, e.g., included in the set of packets 1324, for transmission as a single L4S packet without combination with other L4S packets generated and/or processed at 1322.

The interconnect 1314, at 1326, may process the L4S packets and the non-L4S packets differently. For example, the L4S packets may be associated with a first (hardware) path while non-L4S packets may be associated with a second (hardware) path. In some aspects, the first (hardware) path may omit a buffering operation for the L4S packets and provide the L4S packets to the modem 1312 as they are obtained while the second (hardware) path may accumulate non-L4S packets in a buffer before being provided to the modem 1312. In some aspects, the first path may further be configured to mark the L4S packets with a particular header (e.g., update the IP-ECN field to include the CE codepoint) during an exchange on an interface at the UE. Marking the L4S packets, in some aspects, may be based on the information included in the congestion indication 1320 as described above in relation to the generation and/or processing of the L4S packets at 1322 as the marking operation may be configured to be performed at either the application processor 1316 or the interconnect 1314. For example, the processing at 1326 may include updating ECN associated with one or more of the generated L4S packets based on the one or more radio characteristics and/or based on PDU handling at the UE 1304 indicated in congestion indication 1320. Additionally, or alternatively, the different processing may include determining to drop (or aggregate) one or more non-L4S feedback packets (e.g., TPC ACKs) and skipping a drop of (or determining not to drop) the L4S feedback packet including the aggregated ECN feedback information. In some aspects the second number of PDUs dropped in the one or more PDU sets associated with the first PDU set causes the one or more PDU sets to be dropped based on a first PSIHI associated with the one or more PDU sets and processing and/or updating the ECN associated with the one or more packets based on the PDU handling at the UE is further based on the information relating to the second number of PDUs dropped in the one or more PDU sets included congestion indication 1320.

In some aspects, during the processing at 1326, non-L4S packets may be coalesced and/or combined into PDUs including multiple IP packets while for L4S packets the coalescing and/or combination may be skipped and/or omitted to maintain the information communicated by the percentage of marked L4S packets (e.g., IP packets including the CE codepoint). After the processing at 1326, the interconnect 1314 may output and/or provide, and the modem 1312 may obtain and/or receive, the L4S packets (e.g., in the set of packets 1328). The modem 1312, at 1330 may process the set of packets 1328 including the L4S packets for radio transmission. For example, the packets may be queued and/or buffered, and resources may be requested from the network based on the amount of data in the queue and/or buffer. The modem 1312 may start one or more timers associated with different packets or groups of packets and record or identify an amount of time elapsed between receiving a packet and/or whether the timer has expired as well as any of the other radio characteristics and/or PDU set handling as described above.

After processing the set of data packets at 1330, the modem 1312 may transmit, and the DU 1313 of the base station 1302 may receive, the set of packets 1332. The DU 1313, in some aspects, may provide further processing that does not affect the IP packets (e.g., associated with the MAC and/or RLC processing as illustrated in FIG. 7.) and output, and the CU 1311 of the base station 1302 may obtain, the set of packets 1334. In some aspects, the DU 1313 and the CU 1311 may be collocated in a same physical location as part of a same device, or may be implemented as separate devices at a same or different locations and the communication between the DU 1313 and the CU 1311 may be wired or wireless (e.g., NR-U).

The CU 1311 (and/or a UPF implemented at the CU 1311), in some aspects, may, at 1336, process the set of packets 1334. The processing at 1336 may include, in some aspects, including, in each received uplink (UL) packet of a first plurality of the received UL packets (e.g., a plurality of the L4S packets), ECN information related to radio network delays. The radio network delays, in some aspects, may be based on a PDCP reordering queue that causes successfully received packets associated with a group of packets (e.g., a PDU) associated with PDCP reordering to experience delay based on a last packet of the group to be received. The last packet may be delayed based on radio link level BLER, CC level BLER, slot level BLER, or an MCS level or other failure conditions. In some aspects associated with dual connectivity, delays may be introduced when packets transmitted using a first connection are received with a different timing than other related packets using a second connection.

In some aspects, the ECN information includes a CE indication associated with the L4S service. The CE indication, in some aspects, may be applied to a subset of the “unmarked” L4S packets (e.g., L4S packets identified by the ECT(0) and/or ECT(1) codepoints indicating that the packets are L4S packets but not indicating that the L4S packets have experienced congestion). The first plurality of the received UL packets, in some aspects, may be associated with a reordering queue and experience congestion based on a worst delay experienced by a first packet in the first plurality of received UL packets. For example, an initial transmission of a first and second packet of a PDU group may not be received successfully while a third and fourth packet of a PDU group may be successfully received, but experience a delay associated with waiting for one of a successful reception of (a retransmission of) the first and second packet of the PDU group and/or an expiration of a reordering timer associated with the PDU group. Including the ECN information related to the radio network delays, in some aspects, may be based on the experienced congestion (the congestion based on the radio network delays). In some aspects, the CU 1311 may output and/or transmit, and the core network 1305 may obtain and/or receive, the set of packets 1338 (including the L4S packets).

In some aspects, the core network 1305 may process the L4S packets to generate aggregated ECN information and transmit (e.g., in a TCP ACK), and UE 1304 (and application processor 1316) may receive, ECN feedback 1340 indicating a data rate associated with the application that can be sustained by the E2E network. The application processor 1316, may based on the ECN feedback 1340, update a data rate associated with one or more applications executing on the UE 1304.

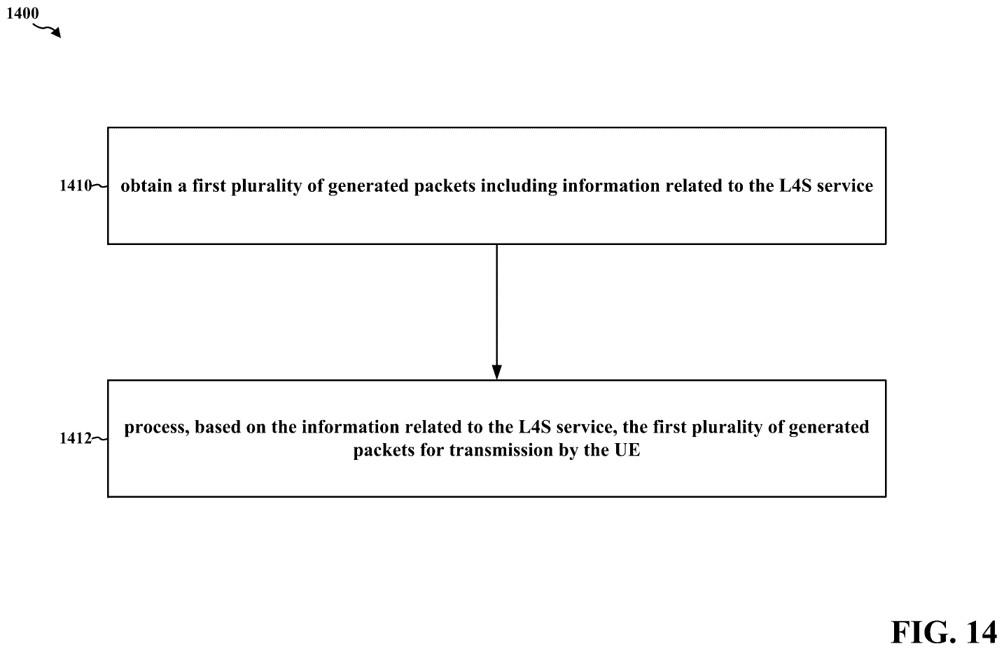

FIG. 14 is a flowchart 1400 of a method of wireless communication. The method may be performed by a UE or a set of components of a UE such as an application processor or an interconnect between the application processor and a modem of the UE (e.g., the UE 104, 704, 1304; the application processor 716, 816, 1316; the interconnect 714, 1314; the modem 712, 812, 1312; the apparatus 1804). For convenience the following description will refer to a UE performing one or more operations with the understanding that the operation may be performed by a component of the UE and that different operations may be performed by different components of the UE. In some aspects, the UE may output a request for information regarding the radio characteristics of a first plurality of generated packets, an indication of a congestion associated with a second flow associated with the first application, and/or information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. For example, referring to FIG. 13, the application processor 1316 and/or the interconnect 1314 of the UE 1304 may output a query 1318.

In some aspects, the UE may obtain information regarding one or more radio characteristics associated with the first plurality of generated packets, an indication of a congestion associated with a second flow associated with the first application, and/or information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. In some aspects, the information regarding the radio characteristics associated with the first plurality of generated packets may include one or more of a first amount of data in a queue for transmission, a data transmission rate, a second amount of data to be transmitted for a first time, a third amount of data not yet acknowledged to be received successfully, a scheduling delay at the UE, a delay associated with re-transmission by the UE, a PDCP reordering delay, a timer based delay at the UE, a HARQ based delay, or an RLC ARQ based delay. L4S packets, in some aspects, may be associated with a first PDU set associated with PDU set metrics including one or more of a PSDB, a PSER, a PSI, or a PSIHI. For example, referring to FIG. 13, the application processor 1316 and/or the interconnect 1314 of the UE 1304 may obtain the congestion indication 1320.

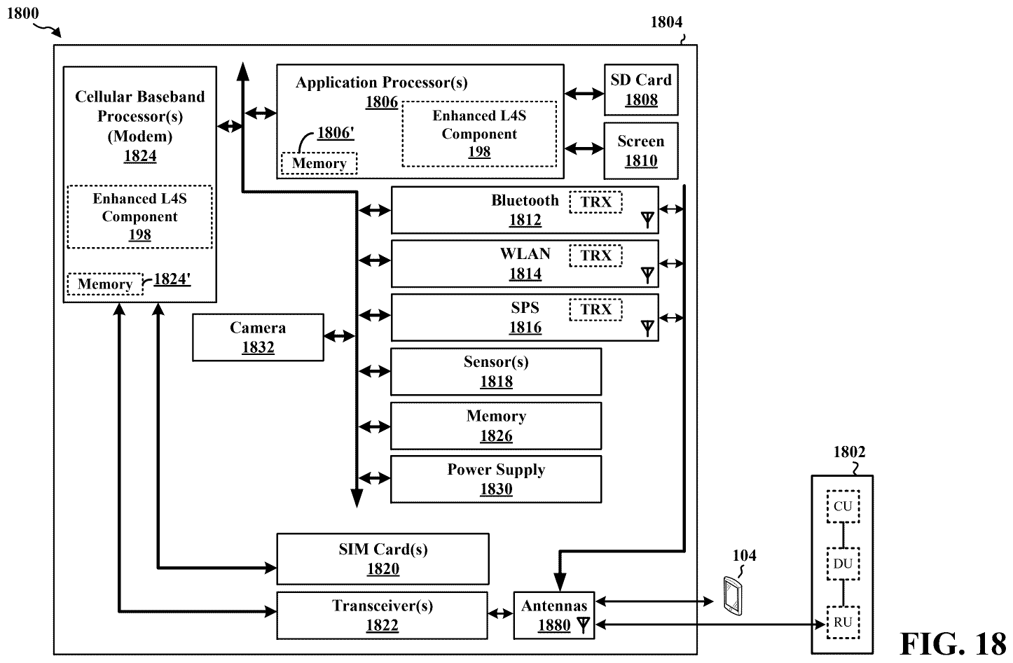

The UE, in some aspects, may control, based on the information regarding the radio characteristics of the first plurality of generated packets, a proportion of L4S service packets in relation to non-L4S service packets. For example, 1406 may be performed by application processor(s) 1806, cellular baseband processor(s) 1824, and/or enhanced L4S component 198 of FIG. 18. In some aspects, the proportion of L4S packets may be reduced to avoid delays associated with queueing and/or buffer build up or may be increased to utilize unused capacity. For example, referring to FIG. 13, the application processor 1316 of the UE 1304 may control the rate of L4S packet generation at 1322.

In some aspects, the UE may control, based on the information regarding the radio characteristics of the first plurality of generated packets, a proportion of L4S service packets marked as experiencing congestion in relation to L4S service packets not marked as experiencing congestion. In some aspects, the proportion of L4S packets may be reduced to avoid delays associated with queueing and/or buffer build up or may be increased to utilize unused capacity. For example, referring to FIG. 13, the application processor 1316 of the UE 1304 may control the number and/or percentage of packets marked as experiencing CE at 1322 based on the congestion indication 1320.

At 1410, the UE may obtain a first plurality of generated packets including information related to the L4S service. In some aspects, obtaining the first plurality of generated packets may include generating the first plurality of generated packets. For example, 1410 may be performed by application processor(s) 1806, cellular baseband processor(s) 1824, and/or enhanced L4S component 198 of FIG. 18. In some aspects, the information related to the L4S service may include ECN such as at least one of an ECT indication that the generated packet is associated with the L4S service or a CE indication that the generated packet has experienced congestion. The information related to the L4S service, in some aspects, may include aggregated ECN feedback for transmission in a TCP ACK packet (e.g., the packet may be an L4S TCP ACK packet). In some aspects, the information related to the L4S service may identify the first plurality of generated packets as L4S traffic. For example, referring to FIG. 13, the application processor 1316 of the UE 1304 may generate, at 1322, L4S packets and/or the interconnect 1314 may obtain the set of packets 1324 including the L4S packets.

At 1412, the UE may process, based on the information related to the L4S service, the first plurality of generated packets for transmission by the UE. The processing at 1412, in some aspects, may occur at an application processor of the UE, an interconnect of the UE, and/or a modem of the UE. In some aspects, the processing at 1412 may include providing the data packet for transmission as a single L4S packet without combination with other L4S packets in the first plurality of generated packets; skipping dropping the TCP ACK packet with the aggregated ECN feedback; providing the first plurality of generated packets via a first (hardware) path for transmission of L4S traffic based on the information related to the L4S service; marking on the first path, the first plurality of generated packets with a particular header during an exchange on an interface at the UE; omitting from the first path a buffering operation for the first plurality of generated packets; updating an ECN associated with one or more of the first plurality of generated packets based on the one or more radio characteristics from the first path a buffering operation for the first plurality of generated packets; updating an ECN associated with one or more packets based on PDU handling at the UE which may be based on the information obtained at 1404 (e.g., the second number of PDUs dropped), and may further include marking the one or more packets of a PDU set based on a PSI based discard at the UE. For example, 1412 may be performed by application processor(s) 1806, cellular baseband processor(s) 1824, and/or enhanced L4S component 198 of FIG. 18. In some aspects, the processing. In some aspects, a first PSI of the first PDU set may be set to high by the processing at 1412 to ensure delivery of the information related to the L4S service. The processing of the first plurality of generated packets at 1412, in some aspects, may be based on the indication of the congestion associated with the second flow obtained at 1404. For example, referring to FIG. 13, the application processor 1316 of the UE 1304 may generate and/or process, at 1322, L4S packets and/or the interconnect 1314 may process, at 1326, the L4S packets in the set of packets 1324 including the L4S packets.

In some aspects, the UE may drop one or more packets in a second plurality of packets that include feedback without aggregated ECN feedback. In some aspects, the dropping of the TCP ACK packets may be performed to reduce overhead, but is skipped for L4S packets (e.g., L4S TCP ACKs carrying aggregated ECN feedback and/or information) to avoid losing information included in the L4S packets. For example, referring to FIG. 13, the interconnect 1314 may process, at 1326, the non-L4S packets in the set of packets 1324 to drop and or consolidate the TCP ACK packets not carrying the aggregated ECN feedback. The UE, in some aspects, may transmit the plurality of generated packets including the information related to the L4S service. For example, referring to FIG. 13, the modem 1312 may transmit the set of packets 1332 including the L4S packets.

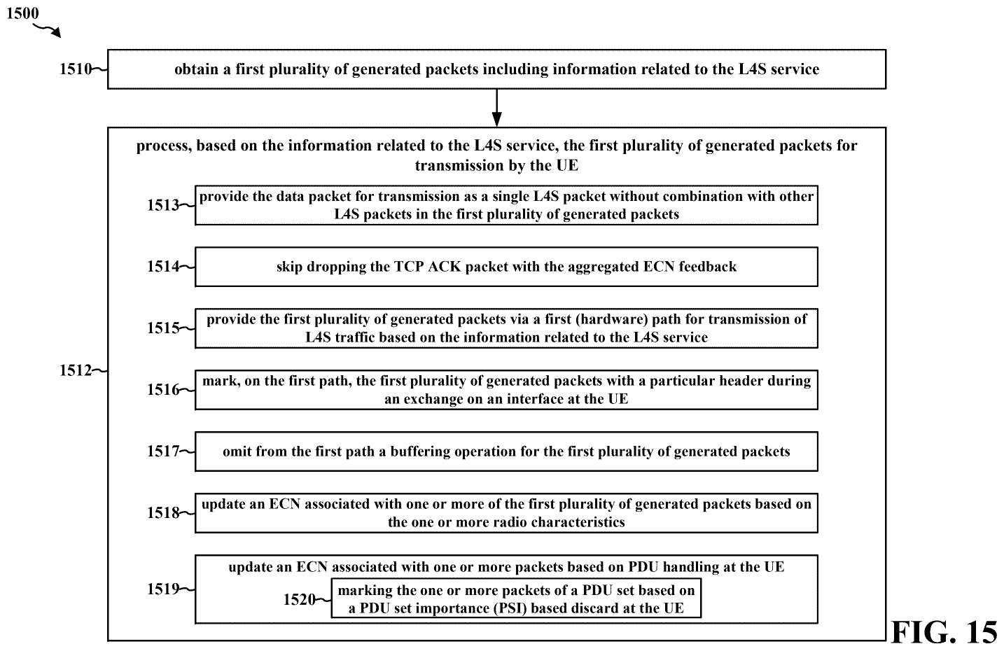

FIG. 15 is a flowchart 1500 of a method of wireless communication. The method may be performed by a UE or a set of components of a UE such as an application processor or an interconnect between the application processor and a modem of the UE (e.g., the UE 104, 704, 1304; the application processor 716, 816, 1316; the interconnect 714, 1314; the modem 712, 812, 1312; the apparatus 1804). For convenience the following description will refer to a UE performing one or more operations with the understanding that the operation may be performed by a component of the UE and that different operations may be performed by different components of the UE. In some aspects, the UE may output a request for information regarding the radio characteristics of a first plurality of generated packets, an indication of a congestion associated with a second flow associated with the first application, and/or information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. For example, referring to FIG. 13, the application processor 1316 and/or the interconnect 1314 of the UE 1304 may output a query 1318.

In some aspects, the UE may obtain information regarding one or more radio characteristics associated with the first plurality of generated packets, an indication of a congestion associated with a second flow associated with the first application, and/or information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. In some aspects, the information regarding the radio characteristics associated with the first plurality of generated packets may include one or more of a first amount of data in a queue for transmission, a data transmission rate, a second amount of data to be transmitted for a first time, a third amount of data not yet acknowledged to be received successfully, a scheduling delay at the UE, a delay associated with re-transmission by the UE, a PDCP reordering delay, a timer based delay at the UE, a HARQ based delay, or an RLC ARQ based delay. L4S packets, in some aspects, may be associated with a first PDU set associated with PDU set metrics including one or more of a PSDB, a PSER, a PSI, or a PSIHI. For example, referring to FIG. 13, the application processor 1316 and/or the interconnect 1314 of the UE 1304 may obtain the congestion indication 1320.

The UE, in some aspects, may control, based on the information regarding the radio characteristics of the first plurality of generated packets, a proportion of L4S service packets in relation to non-L4S service packets. For example, 1506 may be performed by application processor(s) 1806, cellular baseband processor(s) 1824, and/or enhanced L4S component 198 of FIG. 18. In some aspects, the proportion of L4S packets may be reduced to avoid delays associated with queueing and/or buffer build up or may be increased to utilize unused capacity. For example, referring to FIG. 13, the application processor 1316 of the UE 1304 may control the rate of L4S packet generation at 1322.

In some aspects, the UE may control, based on the information regarding the radio characteristics of the first plurality of generated packets, a proportion of L4S service packets marked as experiencing congestion in relation to L4S service packets not marked as experiencing congestion. For example, 1508 may be performed by application processor(s) 1806, cellular baseband processor(s) 1824, and/or enhanced L4S component 198 of FIG. 18. In some aspects, the proportion of L4S packets may be reduced to avoid delays associated with queueing and/or buffer build up or may be increased to utilize unused capacity. For example, referring to FIG. 13, the application processor 1316 of the UE 1304 may control the number and/or percentage of packets marked as experiencing CE at 1322 based on the congestion indication 1320.

At 1510, the UE may obtain a first plurality of generated packets including information related to the L4S service. In some aspects, obtaining the first plurality of generated packets may include generating the first plurality of generated packets. For example, 1510 may be performed by application processor(s) 1806, cellular baseband processor(s) 1824, and/or enhanced L4S component 198 of FIG. 18. In some aspects, the information related to the L4S service may include ECN such as at least one of an ECT indication that the generated packet is associated with the L4S service or a CE indication that the generated packet has experienced congestion. The information related to the L4S service, in some aspects, may include aggregated ECN feedback for transmission in a TCP ACK packet (e.g., the packet may be an L4S TCP ACK packet). In some aspects, the information related to the L4S service may identify the first plurality of generated packets as L4S traffic. For example, referring to FIG. 13, the application processor 1316 of the UE 1304 may generate, at 1322, L4S packets and/or the interconnect 1314 may obtain the set of packets 1324 including the L4S packets.

At 1512, the UE may process, based on the information related to the L4S service, the first plurality of generated packets for transmission by the UE. The processing at 1512, in some aspects, may occur at an application processor of the UE, an interconnect of the UE, and/or a modem of the UE. In some aspects, the processing at 1512 may include providing, at 1513, the data packet for transmission as a single L4S packet without combination with other L4S packets in the first plurality of generated packets; skipping, at 1514, dropping the TCP ACK packet with the aggregated ECN feedback; providing, at 1515, the first plurality of generated packets via a first (hardware) path for transmission of L4S traffic based on the information related to the L4S service; marking, at 1516, on the first path, the first plurality of generated packets with a particular header during an exchange on an interface at the UE; omitting, at 1517, from the first path a buffering operation for the first plurality of generated packets; updating, at 1518, an ECN associated with one or more of the first plurality of generated packets based on the one or more radio characteristics from the first path a buffering operation for the first plurality of generated packets; updating, at 1519, an

ECN associated with one or more packets based on PDU handling at the UE which may be based on the information obtained at 1504 (e.g., the second number of PDUs dropped), and may further include marking, at 1520, the one or more packets of a PDU set based on a PSI based discard at the UE. For example, 1512-1520 may be performed by application processor(s) 1806, cellular baseband processor(s) 1824, and/or enhanced L4S component 198 of FIG. 18. In some aspects, the processing. In some aspects, a first PSI of the first PDU set may be set to high by the processing at 1512 to ensure delivery of the information related to the L4S service. The processing of the first plurality of generated packets at 1512, in some aspects, may be based on the indication of the congestion associated with the second flow obtained at 1504. For example, referring to FIG. 13, the application processor 1316 of the UE 1304 may generate and/or process, at 1322, L4S packets and/or the interconnect 1314 may process, at 1326, the L4S packets in the set of packets 1324 including the L4S packets.

In some aspects, the UE may drop one or more packets in a second plurality of packets that include feedback without aggregated ECN feedback. In some aspects, the dropping of the TCP ACK packets may be performed to reduce overhead, but is skipped at 1514 for L4S packets (e.g., L4S TCP ACKs carrying aggregated ECN feedback and/or information) to avoid losing information included in the L4S packets. For example, referring to FIG. 13, the interconnect 1314 may process, at 1326, the non-L4S packets in the set of packets 1324 to drop and or consolidate the TCP ACK packets not carrying the aggregated ECN feedback. The UE, in some aspects, may transmit the plurality of generated packets including the information related to the L4S service. For example, referring to FIG. 13, the modem 1312 may transmit the set of packets 1332 including the L4S packets.

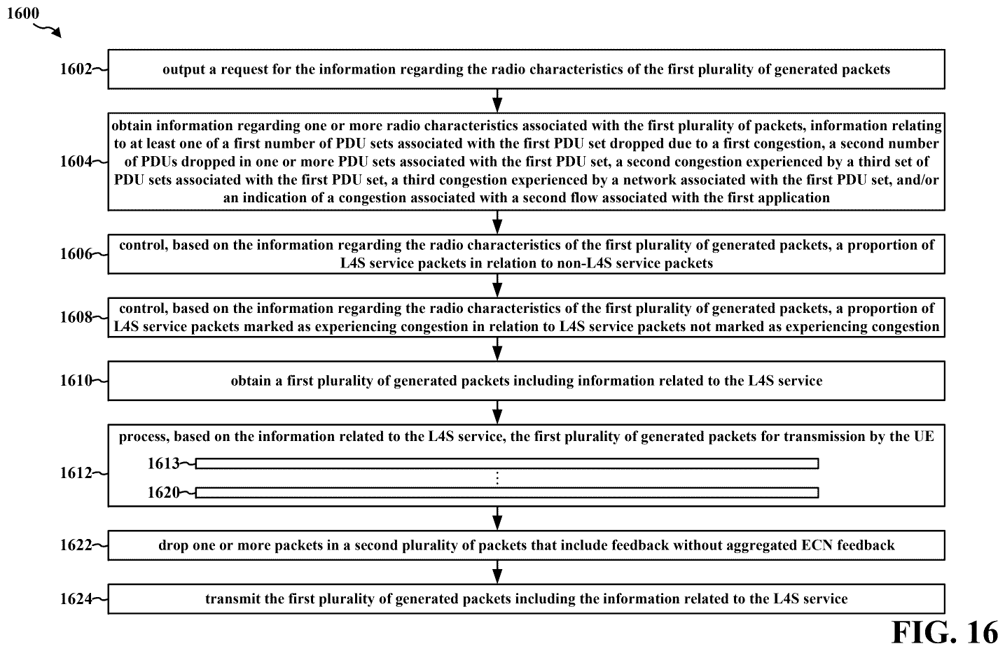

FIG. 16 is a flowchart 1600 of a method of wireless communication. The method may be performed by a UE or a set of components of a UE such as an application processor or an interconnect between the application processor and a modem of the UE (e.g., the UE 104, 704, 1304; the application processor 716, 816, 1316; the interconnect 714, 1314; the modem 712, 812, 1312; the apparatus 1804). For convenience the following description will refer to a UE performing one or more operations with the understanding that the operation may be performed by a component of the UE and that different operations may be performed by different components of the UE. At 1602, the UE may output a request for information regarding the radio characteristics of a first plurality of generated packets, an indication of a congestion associated with a second flow associated with the first application, and/or information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. For example, 1602 may be performed by application processor(s) 1806, cellular baseband processor(s) 1824, and/or enhanced L4S component 198 of FIG. 18. For example, referring to FIG. 13, the application processor 1316 and/or the interconnect 1314 of the UE 1304 may output a query 1318.

At 1604, the UE may obtain information regarding one or more radio characteristics associated with the first plurality of generated packets, an indication of a congestion associated with a second flow associated with the first application, and/or information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. For example, 1604 may be performed by application processor(s) 1806, cellular baseband processor(s) 1824, and/or enhanced L4S component 198 of FIG. 18. In some aspects, the information regarding the radio characteristics associated with the first plurality of generated packets may include one or more of a first amount of data in a queue for transmission, a data transmission rate, a second amount of data to be transmitted for a first time, a third amount of data not yet acknowledged to be received successfully, a scheduling delay at the UE, a delay associated with re-transmission by the UE, a PDCP reordering delay, a timer based delay at the UE, a HARQ based delay, or an RLC ARQ based delay. L4S packets, in some aspects, may be associated with a first PDU set associated with PDU set metrics including one or more of a PSDB, a PSER, a PSI, or a PSIHI. For example, referring to FIG. 13, the application processor 1316 and/or the interconnect 1314 of the UE 1304 may obtain the congestion indication 1320.

At 1606, the UE may control, based on the information regarding the radio characteristics of the first plurality of generated packets, a proportion of L4S service packets in relation to non-L4S service packets. For example, 1606 may be performed by application processor(s) 1806, cellular baseband processor(s) 1824, and/or enhanced L4S component 198 of FIG. 18. In some aspects, the proportion of L4S packets may be reduced to avoid delays associated with queueing and/or buffer build up or may be increased to utilize unused capacity. For example, referring to FIG. 13, the application processor 1316 of the UE 1304 may control the rate of L4S packet generation at 1322.

At 1608, the UE may control, based on the information regarding the radio characteristics of the first plurality of generated packets, a proportion of L4S service packets marked as experiencing congestion in relation to L4S service packets not marked as experiencing congestion. For example, 1608 may be performed by application processor(s) 1806, cellular baseband processor(s) 1824, and/or enhanced L4S component 198 of FIG. 18. In some aspects, the proportion of L4S packets may be reduced to avoid delays associated with queueing and/or buffer build up or may be increased to utilize unused capacity. For example, referring to FIG. 13, the application processor 1316 of the UE 1304 may control the number and/or percentage of packets marked as experiencing CE at 1322 based on the congestion indication 1320.

At 1610, the UE may obtain a first plurality of generated packets including information related to the L4S service. In some aspects, obtaining the first plurality of generated packets may include generating the first plurality of generated packets. For example, 1610 may be performed by application processor(s) 1806, cellular baseband processor(s) 1824, and/or enhanced L4S component 198 of FIG. 18. In some aspects, the information related to the L4S service may include ECN such as at least one of an ECT indication that the generated packet is associated with the L4S service or a CE indication that the generated packet has experienced congestion. The information related to the L4S service, in some aspects, may include aggregated ECN feedback for transmission in a TCP ACK packet (e.g., the packet may be an L4S TCP ACK packet). In some aspects, the information related to the L4S service may identify the first plurality of generated packets as L4S traffic. For example, referring to FIG. 13, the application processor 1316 of the UE 1304 may generate, at 1322, L4S packets and/or the interconnect 1314 may obtain the set of packets 1324 including the L4S packets.

At 1612, the UE may process, based on the information related to the L4S service, the first plurality of generated packets for transmission by the UE. The processing at 1612, in some aspects, may occur at an application processor of the UE, an interconnect of the UE, and/or a modem of the UE. In some aspects, the processing at 1612 may include one or more of a set of operations 1613 to 1620 corresponding to 1513 to 1520 of FIG. 15. For example, the processing at 1612 may include one or more of providing the data packet for transmission as a single L4S packet without combination with other L4S packets in the first plurality of generated packets; skipping dropping the TCP ACK packet with the aggregated ECN feedback; providing the first plurality of generated packets via a first (hardware) path for transmission of L4S traffic based on the information related to the L4S service; marking on the first path, the first plurality of generated packets with a particular header during an exchange on an interface at the UE; omitting from the first path a buffering operation for the first plurality of generated packets; updating an ECN associated with one or more of the first plurality of generated packets based on the one or more radio characteristics from the first path a buffering operation for the first plurality of generated packets; updating an ECN associated with one or more packets based on PDU handling at the UE which may be based on the information obtained at 1604 (e.g., the second number of PDUs dropped), and may further include marking the one or more packets of a PDU set based on a PSI based discard at the UE. For example, 1612-1620 may be performed by application processor(s) 1806, cellular baseband processor(s) 1824, and/or enhanced L4S component 198 of FIG. 18. In some aspects, the processing. In some aspects, a first PSI of the first PDU set may be set to high by the processing at 1612 to ensure delivery of the information related to the L4S service. The processing of the first plurality of generated packets at 1612, in some aspects, may be based on the indication of the congestion associated with the second flow obtained at 1604. For example, referring to FIG. 13, the application processor 1316 of the UE 1304 may generate and/or process, at 1322, L4S packets and/or the interconnect 1314 may process, at 1326, the L4S packets in the set of packets 1324 including the L4S packets.

At 1622, the UE may drop one or more packets in a second plurality of packets that include feedback without aggregated ECN feedback. For example, 1622 may be performed by application processor(s) 1806, cellular baseband processor(s) 1824, and/or enhanced L4S component 198 of FIG. 18. In some aspects, the dropping of the TCP ACK packets may be performed to reduce overhead, but is skipped at 1614 for L4S packets (e.g., L4S TCP ACKs carrying aggregated ECN feedback and/or information) to avoid losing information included in the L4S packets. For example, referring to FIG. 13, the interconnect 1314 may process, at 1326, the non-L4S packets in the set of packets 1324 to drop and or consolidate the TCP ACK packets not carrying the aggregated ECN feedback.

At 1624, the UE may transmit the plurality of generated packets including the information related to the L4S service. For example, 1624 may be performed by application processor(s) 1806, cellular baseband processor(s) 1824, and/or enhanced L4S component 198 of FIG. 18. For example, referring to FIG. 13, the modem 1312 may transmit the set of packets 1332 including the L4S packets.

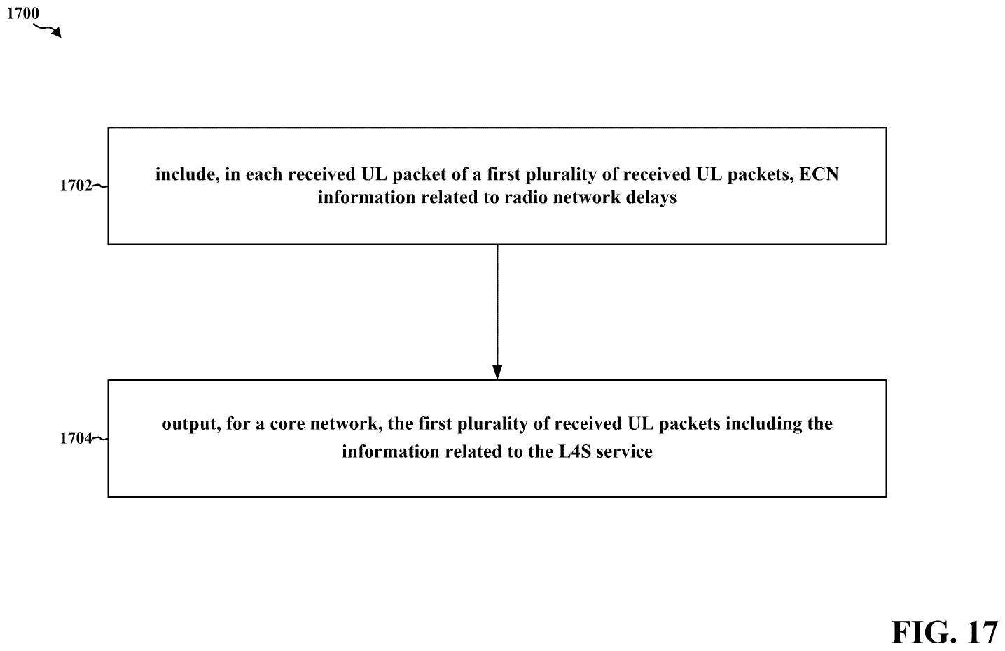

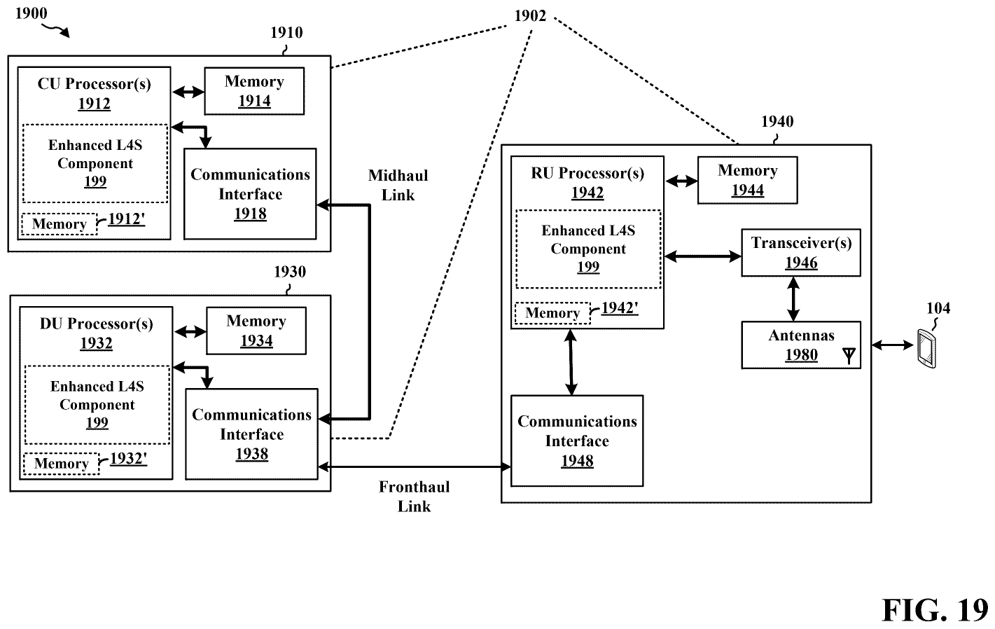

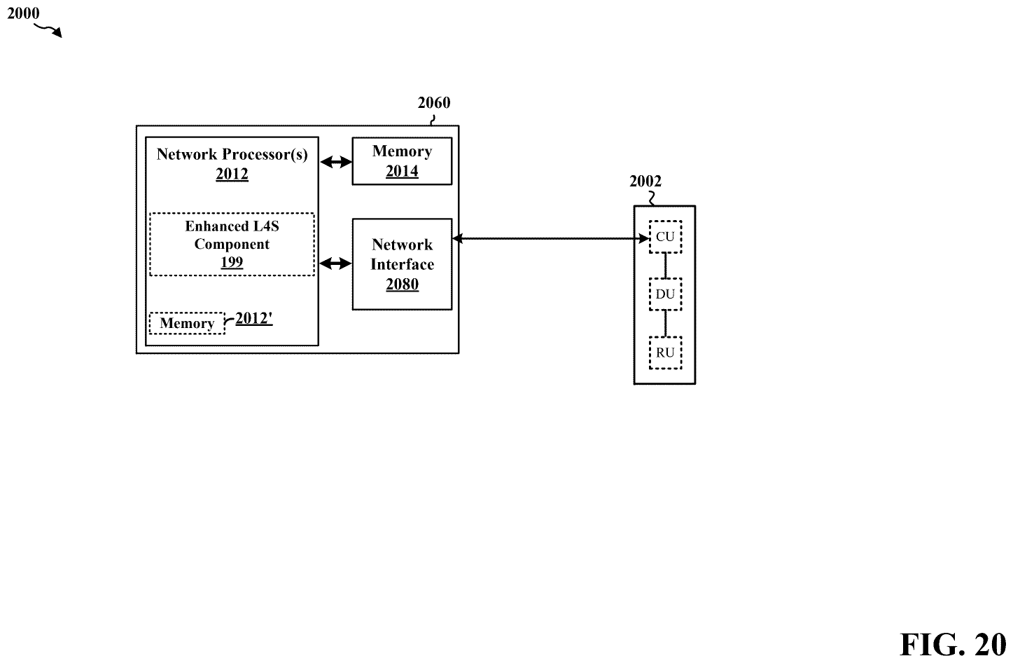

FIG. 17 is a flowchart 1700 of a method of wireless communication. The method may be performed by a network device, e.g., a network device implementing a UPF such as a base station or a component of the base station and/or a core network (e.g., the base station 102, 702, 1302; the core network 120, 705, 1305; the UPF 163; the network entity 1802, 1902, 2060). At 1702, the network device may include, in each received UL packet of a first plurality of received UL packets, ECN information related to radio network delays. For example, 1702 may be performed by CU processor(s) 1912, DU processor(s) 1932, RU processor(s) 1942, network processor 2012, network interface 2080, and/or enhanced L4S component 199 of FIGS. 19 and 20. In some aspects, the ECN information may include a CE indication associated with the L4S service. The first plurality of received UL packets, in some aspects, may be associated with a reordering queue and experience congestion based on a worst delay experienced by a first packet in the first plurality of received UL packets, and including the ECN information related to the radio network delays may be based on the experienced congestion. In some aspects, the first plurality of received UL packets is associated with a non-zero packet loss, and including the ECN information related to the radio network delays is based on the (non-zero) packet loss. The non-zero packet loss, in some aspects, is associated with at least one of a first threshold number of lost packets within a first time window, a second threshold percentage of lost packets over a second time window. For example, referring to FIG. 13, the CU 1311 and/or the core network 1305 may perform packet processing at 1336.

At 1704, the network device may output, for a core network (and/or additional elements of the core network), the first plurality of received UL packets including the information related to the L4S service. For example, 1704 may be performed by CU processor(s) 1912, DU processor(s) 1932, RU processor(s) 1942, network processor 2012, network interface 2080, and/or enhanced L4S component 199 of FIGS. 19 and 20. For example, referring to FIG. 13, the CU 1311 may transmit the set of packets 1338 to the core network 1305.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize one or more antennas 1880 for communication. The cellular baseband processor(s) 1824 communicates through the transceiver(s) 1822 via the one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

As discussed supra, the enhanced L4S component 198 may be configured to obtain a first plurality of generated packets including information related to the L4S service and process, based on the information related to the L4S service, the first plurality of generated packets for transmission by the UE. The enhanced L4S component 198 may be within the cellular baseband processor(s) 1824, the application processor(s) 1806, or both the cellular baseband processor(s) 1824 and the application processor(s) 1806. The enhanced L4S component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, may include means for obtaining a first plurality of generated packets including information related to the L4S service. The apparatus 1804, and in particular the cellular baseband processor(s) 1824 and/or the application processor(s) 1806, may include means for processing, based on the information related to the L4S service, the first plurality of generated packets for transmission by the UE. The apparatus 1804, and in particular the cellular baseband processor(s) 1824 and/or the application processor(s) 1806, may include means for outputting a request for the information regarding the radio characteristics of the first plurality of generated packets. The apparatus 1804, and in particular the cellular baseband processor(s) 1824 and/or the application processor(s) 1806, may include means for obtaining information regarding one or more radio characteristics associated with the first plurality of generated packets. The apparatus 1804, and in particular the cellular baseband processor(s) 1824 and/or the application processor(s) 1806, may include means for controlling, based on the information regarding the radio characteristics of the first plurality of generated packets, a proportion of L4S service packets in relation to non-L4S service packets. The apparatus 1804, and in particular the cellular baseband processor(s) 1824 and/or the application processor(s) 1806, may include means for controlling, based on the information regarding the radio characteristics of the first plurality of generated packets, a proportion of L4S service packets marked as experiencing congestion in relation to L4S service packets not marked as experiencing congestion. The apparatus 1804, and in particular the cellular baseband processor(s) 1824 and/or the application processor(s) 1806, may include means for providing the data packet for transmission as a single L4S packet without combination with other L4S packets in the first plurality of generated packets. The apparatus 1804, and in particular the cellular baseband processor(s) 1824 and/or the application processor(s) 1806, may include means for skipping dropping the TCP ACK packet with the aggregated ECN feedback. The apparatus 1804, and in particular the cellular baseband processor(s) 1824 and/or the application processor(s) 1806, may include means for dropping one or more packets in a second plurality of packets that include feedback without aggregated ECN feedback. The apparatus 1804, and in particular the cellular baseband processor(s) 1824 and/or the application processor(s) 1806, may include means for providing the first plurality of generated packets via a first path for transmission of L4S traffic based on the information related to the L4S service. The apparatus 1804, and in particular the cellular baseband processor(s) 1824 and/or the application processor(s) 1806, may include means for marking, on the first path, the first plurality of generated packets with a particular header during an exchange on an interface at the UE. The apparatus 1804, and in particular the cellular baseband processor(s) 1824 and/or the application processor(s) 1806, may include means for omitting from the first path a buffering operation for the first plurality of generated packets. The apparatus 1804, and in particular the cellular baseband processor(s) 1824 and/or the application processor(s) 1806, may include means for updating an explicit congestion notification (ECN) associated with one or more of the first plurality of generated packets based on the one or more radio characteristics. The apparatus 1804, and in particular the cellular baseband processor(s) 1824 and/or the application processor(s) 1806, may include means for updating an ECN associated with one or more packets based on PDU handling at the UE. The apparatus 1804, and in particular the cellular baseband processor(s) 1824 and/or the application processor(s) 1806, may include means for marking the one or more packets of a PDU set based on a PSI based discard at the UE. The apparatus 1804, and in particular the cellular baseband processor(s) 1824 and/or the application processor(s) 1806, may include means for obtaining information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set. The apparatus 1804, and in particular the cellular baseband processor(s) 1824 and/or the application processor(s) 1806, may include means for obtaining an indication of a congestion associated with a second flow associated with the first application. The apparatus 1804 may further include means for performing any of the aspects described in connection with the flowcharts in FIGS. 14-17, and/or performed by the UE (or the components of the UE) in the communication flow of FIG. 13. The means may be the enhanced L4S component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the enhanced L4S component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912. The CU processor(s) 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932. The DU processor(s) 1932 may include on-chip memory 1932′. In some aspects, the DU 1930 may further include additional memory modules 1934 and a communications interface 1938. The DU 1930 communicates with the RU 1940 through a fronthaul link. The RU 1940 may include at least one RU processor 1942. The RU processor(s) 1942 may include on-chip memory 1942′. In some aspects, the RU 1940 may further include additional memory modules 1944, one or more transceivers 1946, one or more antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the enhanced L4S component 199 may be configured to include, in each received UL packet of a first plurality of received UL packets, ECN information related to radio network delays and output, for a core network, the first plurality of received UL packets including the information related to the L4S service. The enhanced L4S component 199 may be within one or more processors of one or more of the CU 1910, DU 1930, and the RU 1940. The enhanced L4S component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 may include means for including, in each received UL packet of a first plurality of received UL packets, ECN information related to radio network delays. In some aspects, the network entity 1902 may include means for outputting, for a core network, the first plurality of received UL packets including the information related to the L4S service. The network entity 1902 may further include means for performing any of the aspects described in connection with the flowcharts in FIG. 17, and/or performed by the base station and/or core network in the communication flow of FIG. 13. The means may be the enhanced L4S component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIG. 13.

FIG. 20 is a diagram 2000 illustrating an example of a hardware implementation for a network entity 2060. In one example, the network entity 2060 may be within the core network 120. The network entity 2060 may include at least one network processor 2012. The network processor(s) 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The network processor(s) 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the enhanced L4S component 199 may be configured to include, in each received UL packet of a first plurality of received UL packets, ECN information related to radio network delays and output, for a core network, the first plurality of received UL packets including the information related to the L4S service. The enhanced L4S component 199 may be within the network processor(s) 2012. The enhanced L4S component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2060 may include a variety of components configured for various functions. In one configuration, the network entity 2060 may include means for including, in each received UL packet of a first plurality of received UL packets, ECN information related to radio network delays. In some aspects, the network entity 2060 may include means for outputting, for a core network, the first plurality of received UL packets including the information related to the L4S service. The means may be the enhanced L4S component 199 of the network entity 2060 configured to perform the functions recited by the means. As described supra, the network entity 2060 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIG. 13.

Various aspects relate generally to enhancing and/or extending L4S traffic handling to ensure the benefits of the L4S in the cellular environment to provide the overall end-to-end data KPIs. Some aspects more specifically relate to treating L4S traffic differently in a radio environment (e.g., wireless communication) based on protocol and configuration aspects of the radio environment specific to technology and/or topology of the components of the radio environment. Various aspects further relate more specifically to UL transmissions from a UL application processor and/or modem of a UE and network UPF processing of the UL transmissions. In some examples, a wireless device may be configured to obtain a first plurality of generated packets including information related to the L4S service and process, based on the information related to the L4S service, the first plurality of generated packets for transmission by the UE. In some examples, a network device may be configured to include, in each received UL packet of a first plurality of received UL packets, ECN information related to radio network delays and output, for a core network, the first plurality of received UL packets including the ECN information related to the L4S service.

Particular aspects of the subject matter described in this disclosure can be implemented to realize one or more of the following potential advantages. In some examples, by enhancing and/or extending L4S traffic handling, the described techniques can be used to address the queuing delay and buffer handling aspects to have enhanced E2E application level KPIs to improve the SLA aspects of the application (e.g., a user experience).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication associated with a low latency low loss scalable throughput (L4S) service at a user equipment (UE), comprising: obtaining a first plurality of generated packets including information related to the L4S service; and processing, based on the information related to the L4S service, the first plurality of generated packets for transmission by the UE.

Aspect 2 is the method of aspect 1, wherein the information related to the L4S service comprises at least one of an explicit congestion notification (ECN) capable transport (ECT) indication that a generated packet in the first plurality of generated packets is associated with the L4S service or a congestion experienced (CE) indication that the generated packet has experienced congestion.

Aspect 3 is the method of any of aspects 1 and 2, wherein the information related to the L4S service includes explicit congestion notification (ECN) information for a data packet, and wherein processing the first plurality of generated packets comprises: providing the data packet for transmission as a single L4S packet without combination with other L4S packets in the first plurality of generated packets.

Aspect 4 is the method of any of aspects 1 to 3, wherein the information related to the L4S service includes aggregated explicit congestion notification (ECN) feedback for transmission in a transmission control protocol (TCP) acknowledgement (ACK) packet, and wherein processing the first plurality of generated packets comprises: skipping dropping the TCP ACK packet with the aggregated ECN feedback, wherein the method further includes: dropping one or more packets in a second plurality of packets that include feedback without aggregated ECN feedback.

Aspect 5 is the method of any of aspects 1 to 4, wherein the information related to the L4S service identifies the first plurality of generated packets as L4S traffic, and wherein the processing the first plurality of generated packets includes: providing the first plurality of generated packets via a first hardware path for transmission of the L4S traffic based on the information related to the L4S service, wherein the first hardware path is different than a second hardware path for non-L4S traffic.

Aspect 6 is the method of aspect 5, wherein the processing the first plurality of generated packets further includes: marking, on the first path, the first plurality of generated packets with a particular header during an exchange on an interface at the UE.

Aspect 7 is the method of any of aspects 5 and 6, wherein processing the first plurality of generated packets further comprises omitting from the first path a buffering operation for the first plurality of generated packets.

Aspect 8 is the method of any of aspects 1 to 7, further comprising: obtaining additional information regarding one or more radio characteristics associated with the first plurality of generated packets, wherein processing the first plurality of generated packets includes: updating an explicit congestion notification (ECN) associated with one or more of the first plurality of generated packets based on the one or more radio characteristics.

Aspect 9 is the method of aspect 8, wherein the additional information regarding the one or more radio characteristics associated with the first plurality of generated packets comprises one or more of: an amount of data in a queue for transmission, a data transmission rate, a first amount of data to be transmitted for a first time, a second amount of data not yet acknowledged to be received successfully, a scheduling delay at the UE, a delay associated with re-transmission by the UE, a PDCP reordering delay, a timer based delay at the UE, a HARQ based delay, or an RLC ARQ based delay.

Aspect 10 is the method of any of aspects 8 and 9, further comprising: outputting a request for the additional information regarding the one or more radio characteristics of the first plurality of generated packets, wherein obtaining the additional information regarding the one or more radio characteristics of the first plurality of generated packets is based on the request.

Aspect 11 is the method of any of aspects 8 and 9, further comprising: controlling, based on the additional information regarding the one or more radio characteristics of the first plurality of generated packets, a proportion of L4S service packets in relation to non-L4S service packets.

Aspect 12 is the method of any of aspects 8 to 11, wherein updating the ECN further comprises: controlling, based on the additional information regarding the one or more radio characteristics of the first plurality of generated packets, a proportion of L4S service packets marked as experiencing congestion in relation to L4S service packets not marked as experiencing the congestion.

Aspect 13 is the method of any of aspects 8 to 12, wherein updating the ECN associated with the one or more of the first plurality of generated packets is performed at one of an application server of the UE or an interconnect between the application server of the UE and a modem of the UE.

Aspect 14 is the method of any of aspects 1 to 13, wherein processing the first plurality of generated packets includes: updating an explicit congestion notification (ECN) associated with one or more packets based on protocol data unit (PDU) handling at the UE.

Aspect 15 is the method of aspect 14, wherein updating the ECN associated with one or more packets includes: marking the one or more packets of a PDU set based on a PDU set importance (PSI) based discard at the UE.

Aspect 16 is the method of any of aspects 14 and 15, wherein the first plurality of generated packets are associated with a first packet data unit (PDU) set associated with PDU set metrics including one or more of a PDU set delay budget (PSDB), a PDU set error rate (PSER), a PS importance (PSI), or a PDU set integrity handling indicator (PSIHI), the method further comprising: obtaining additional information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set, wherein updating the ECN associated with the one or more packets is based on the additional information.

Aspect 17 is the method of aspect 16, wherein a first PSI of the first PDU set is set to high to ensure delivery of the information related to the L4S service.

Aspect 18 is the method of any of aspects 16 and 17, wherein the second number of PDUs dropped in the one or more PDU sets associated with the first PDU set causes the one or more PDU sets to be dropped based on a first PSIHI associated with the one or more PDU sets and updating the ECN associated with the one or more packets based on the PDU handling at the UE is further based on the second number of PDUs dropped.

Aspect 19 is the method of any of aspects 16 to 18, wherein the obtained information relates to the second congestion experienced by the third set of PDU sets and updating the ECN associated with the one or more packets based on the PDU handling at the UE is further based on the obtained information.

Aspect 20 is the method of any of aspects 1 to 19, wherein the first plurality of generated packets is associated with a first flow associated with a first application, the method further comprising: obtaining an indication of a congestion associated with a second flow associated with the first application, wherein processing the first plurality of generated packets is based on the indication of the congestion associated with the second flow.

Aspect 21 is the method of any of aspects 1 to 20, wherein processing the first plurality of generated packets for transmission by the UE is performed at one of an application server of the UE or an interconnect between the application server of the UE and a modem of the UE, wherein the interconnect is a data exchange path comprising one of a universal serial bus (USB) or a peripheral component interconnect express (PCIe).

Aspect 22 is a method of wireless communication associated with a low latency low loss scalable throughput (L4S) service at a network device, comprising: including, in each received uplink (UL) packet of a first plurality of received UL packets, explicit congestion notification (ECN) information related to radio network delays; and outputting, for a core network, the first plurality of received UL packets including the ECN information related to the L4S service.

Aspect 23 is the method of aspect 22, wherein the ECN information comprises a congestion experienced (CE) indication associated with the L4S service.

Aspect 24 is the method of aspect 23, wherein the first plurality of received UL packets is associated with a reordering queue and experience congestion based on a worst delay experienced by a first packet in the first plurality of received UL packets, and including the ECN information related to the radio network delays is based on the congestion.

Aspect 25 is the method of any of aspects 23 and 24, wherein the first plurality of received UL packets is associated with a non-zero packet loss, and including the ECN information related to the radio network delays is based on the non-zero packet loss.

Aspect 26 is the method of aspect 25, wherein the non-zero packet loss is associated with at least one of a first threshold number of lost packets within a first time window and a second threshold percentage of lost packets over a second time window.

Aspect 27 is an apparatus for wireless communication at a device including a memory and at least one processor coupled to the memory and, based at least in part on information stored in the memory, the at least one processor is configured to implement any of aspects 1 to 21.

Aspect 28 is the apparatus of aspect 27, further including a transceiver or an antenna coupled to the at least one processor.

Aspect 29 is an apparatus for wireless communication at a device including means for implementing any of aspects 1 to 21.

Aspect 30 is a computer-readable medium (e.g., a non-transitory computer-readable medium) storing computer executable code, where the code when executed by a processor causes the processor to implement any of aspects 1 to 21.

Aspect 31 is an apparatus for wireless communication at a device including a memory and at least one processor coupled to the memory and, based at least in part on information stored in the memory, the at least one processor is configured to implement any of aspects 22 to 26.

Aspect 32 is the apparatus of aspect 31, further including a transceiver or an antenna coupled to the at least one processor.

Aspect 33 is an apparatus for wireless communication at a device including means for implementing any of aspects 22 to 26.

Aspect 34 is a computer-readable medium (e.g., a non-transitory computer-readable medium) storing computer executable code, where the code when executed by a processor causes the processor to implement any of aspects 22 to 26.

What is claimed is:

1. An apparatus for wireless communication at a user equipment (UE) associated with a low latency low loss scalable throughput (L4S) service, comprising:
at least one memory; and
at least one processor coupled to the at least one memory and, based at least in part on stored information that is stored in the at least one memory, the at least one processor, individually or in any combination, is configured to:
obtain a first plurality of generated packets including information related to the L4S service; and
process, based on the information related to the L4S service, the first plurality of generated packets for transmission by the UE.

2. The apparatus of claim 1, wherein the information related to the L4S service comprises at least one of an explicit congestion notification (ECN) capable transport (ECT) indication that a generated packet in the first plurality of generated packets is associated with the L4S service or a congestion experienced (CE) indication that the generated packet has experienced congestion.

3. The apparatus of claim 1, wherein the information related to the L4S service includes explicit congestion notification (ECN) information for a data packet, and wherein to process the first plurality of generated packets, the at least one processor, individually or in any combination, is configured to:
provide the data packet for the transmission as a single L4S packet without combination with other L4S packets in the first plurality of generated packets.

4. The apparatus of claim 1, wherein the information related to the L4S service includes aggregated explicit congestion notification (ECN) feedback for transmission in a transmission control protocol (TCP) acknowledgement (ACK) packet, and wherein to process the first plurality of generated packets, the at least one processor, individually or in any combination, is configured to:
skip dropping the TCP ACK packet with the aggregated ECN feedback, wherein the at least one processor, individually or in any combination, is further configured to:
drop one or more packets in a second plurality of packets that include feedback without aggregated ECN feedback.

5. The apparatus of claim 1, wherein the information related to the L4S service identifies the first plurality of generated packets as L4S traffic, and wherein to process the first plurality of generated packets, the at least one processor, individually or in any combination, is configured to:
provide the first plurality of generated packets via a first hardware path for the transmission of the L4S traffic based on the information related to the L4S service, wherein the first hardware path is different than a second hardware path for non-L4S traffic; and
mark, on the first hardware path, the first plurality of generated packets with a particular header during an exchange on an interface at the UE.

6. The apparatus of claim 5, wherein to process the first plurality of generated packets, the at least one processor, individually or in any combination, is configured to omit from the first hardware path a buffering operation for the first plurality of generated packets.

7. The apparatus of claim 1, wherein the at least one processor, individually or in any combination, is further configured to:
obtain additional information regarding one or more radio characteristics associated with the first plurality of generated packets, and wherein to process the first plurality of generated packets, the at least one processor, individually or in any combination, is further configured to update an explicit congestion notification (ECN) associated with one or more of the first plurality of generated packets based on the one or more radio characteristics at one of an application server of the UE or an interconnect between the application server of the UE and a modem of the UE.

8. The apparatus of claim 7, wherein the additional information regarding the one or more radio characteristics associated with the first plurality of generated packets comprises one or more of:
an amount of data in a queue for transmission,
a data transmission rate,
a first amount of data to be transmitted for a first time,
a second amount of data not yet acknowledged to be received successfully,
a scheduling delay at the UE,
a delay associated with re-transmission by the UE,
a PDCP reordering delay,
a timer based delay at the UE,
a HARQ based delay, or
an RLC ARQ based delay.

9. The apparatus of claim 7, wherein the at least one processor, individually or in any combination, is further configured to:
output a request for the additional information regarding the one or more radio characteristics of the first plurality of generated packets, wherein the at least one processor, individually or in any combination, is further configured to obtain the additional information regarding the one or more radio characteristics of the first plurality of generated packets based on the request.

10. The apparatus of claim 7 wherein the at least one processor, individually or in any combination, is further configured to:
control, based on the additional information regarding the one or more radio characteristics of the first plurality of generated packets, a proportion of L4S service packets in relation to non-L4S service packets, wherein an additional proportion of a first set of L4S service packets marked as experiencing congestion in relation to a second set of L4S service packets not marked as experiencing the congestion is based on the additional information regarding the one or more radio characteristics of the first plurality of generated packets.

11. The apparatus of claim 1, wherein to process the first plurality of generated packets, the at least one processor, individually or in any combination, is configured to:
update an explicit congestion notification (ECN) associated with one or more packets based on protocol data unit (PDU) handling at the UE by marking the one or more packets of a PDU set based on a PDU set importance (PSI) based discard at the UE.

12. The apparatus of claim 11, wherein the first plurality of generated packets are associated with a first packet data unit (PDU) set associated with PDU set metrics including one or more of a PDU set delay budget (PSDB), a PDU set error rate (PSER), the PSI, or a PDU set integrity handling indicator (PSIHI), and wherein the at least one processor, individually or in any combination, is further configured to:
obtain additional information relating to at least one of a first number of PDU sets associated with the first PDU set dropped due to a first congestion, a second number of PDUs dropped in one or more PDU sets associated with the first PDU set, a second congestion experienced by a third set of PDU sets associated with the first PDU set, a third congestion experienced by a network associated with the first PDU set, wherein, to update the ECN associated with the one or more packets, the at least one processor, individually or in any combination is further configured to update the ECN associated with the one or more packets based on the additional information, and wherein a first PSI of the first PDU set is set to high to ensure delivery of the information related to the L4S service.

13. The apparatus of claim 12, wherein the second number of PDUs dropped in the one or more PDU sets associated with the first PDU set causes the one or more PDU sets to be dropped based on a first PSIHI associated with the one or more PDU sets and wherein, to update the ECN associated with the one or more packets, the at least one processor, individually or in any combination is further configured to update the ECN associated with the one or more packets based on the second number of PDUs dropped.

14. The apparatus of claim 12, wherein the additional information relates to the second congestion experienced by the third set of PDU sets and wherein the at least one processor, individually or in any combination is configured to update the ECN associated with the one or more packets based on the PDU handling at the UE further based on the additional information.

15. The apparatus of claim 1, wherein the first plurality of generated packets is associated with a first flow associated with a first application, the at least one processor, individually or in any combination, is further configured to:
obtain an indication of a congestion associated with a second flow associated with the first application, wherein the at least one processor, individually or in any combination is configured to process the first plurality of generated packets based on the indication of the congestion associated with the second flow.

16. The apparatus of claim 1, wherein processing the first plurality of generated packets for the transmission by the UE is performed at one of an application server of the UE or an interconnect between the application server of the UE and a modem of the UE, wherein the interconnect is a data exchange path comprising one of a universal serial bus (USB) or a peripheral component interconnect express (PCIe).

17. A method of wireless communication associated with a low latency low loss scalable throughput (L4S) service at a user equipment (UE), comprising:
obtaining a first plurality of generated packets including information related to the L4S service; and
processing, based on the information related to the L4S service, the first plurality of generated packets for transmission by the UE.

18. The method of claim 17, further comprising:
obtaining additional information regarding one or more radio characteristics associated with the first plurality of generated packets, wherein processing the first plurality of generated packets includes:
updating an explicit congestion notification (ECN) associated with one or more of the first plurality of generated packets based on the one or more radio characteristics.

19. An apparatus for wireless communication at a network device associated with a low latency low loss scalable throughput (L4S) service, comprising:
at least one memory; and
at least one processor coupled to the at least one memory and, based at least in part on stored information that is stored in the at least one memory, the at least one processor, individually or in any combination, is configured to:
include, in each received uplink (UL) packet of a first plurality of received UL packets, explicit congestion notification (ECN) information related to radio network delays; and
output, for a core network, the first plurality of received UL packets including the ECN information related to the L4S service.

20. The apparatus of claim 19, wherein the ECN information comprises a congestion experienced (CE) indication associated with the L4S service, and wherein one of:
the first plurality of received UL packets is associated with a reordering queue and experience congestion based on a worst delay experienced by a first packet in the first plurality of received UL packets, and wherein the at least one processor, individually or in any combination is further configured to include the ECN information related to the radio network delays based on the congestion; or
the first plurality of received UL packets is associated with a non-zero packet loss that is associated with at least one of a first threshold number of lost packets within a first time window and a second threshold percentage of lost packets over a second time window, and wherein the at least one processor, individually or in any combination is further configured to include the ECN information related to the radio network delays based on the non-zero packet loss.
